(19) United States
(12) Patent Application Publication
(10) Pub. No.: US 2017/0184533 A1
(43) Pub. Date: Jun. 29, 2017

(54) METHODS FOR DETERMINING ANALYTES IN FLUIDS

(71) Applicant: Daktari Diagnostics, Inc., Cambridge, MA (US)

(72) Inventors: Marta Fernández Suárez, Cambridge, MA (US); Lisa Marshall, Cambridge, MA (US); Martina Medkova, Winchester, MA (US); Aaron Oppenheimer, Cambridge, MA (US)

(73) Assignee: Daktari Diagnostics, Inc., Cambridge, MA (US)

(21) Appl. No.: 15/367,250

(22) Filed: Dec. 2, 2016

Related U.S. Application Data
(60) Provisional application No. 62/263,399, filed on Dec. 4, 2015.

(51) Int. Cl. G01N 27/327; G01N 27/416

(52) U.S. Cl. CPC G01N 27/327; G01N 27/3273; G01N 27/416; G01N 2458/30

(57) ABSTRACT

Methods for determining and/or quantifying one or more analytes in fluids are generally provided. In some embodiments, a method comprises introducing or exposing a plurality of conjugated capture structures and a plurality of metal-containing (e.g., silver) conjugated particles to a fluid comprising the analyte such that the analyte binds with both a capture structure and a metal-containing (e.g., silver) particle to form a bound complex. The bound complex may then be subjected to conditions (e.g., electrochemical conditions) that allow quantification of the analyte based on the amount of metal-containing particles present. The methods described herein may be useful for determining and quantifying relatively low concentrations of analytes present in a patient sample (e.g., a droplet of whole blood).

### RELATED APPLICATIONS

The present application claims priority to U.S. Provisional Application No. 62/263,399, filed Dec. 4, 2015, which is hereby incorporated by reference in its entirety for all purposes.

### TECHNICAL FIELD

The present invention generally relates to methods for determining and/or quantifying one or more analytes in fluids.

### SUMMARY

The present invention generally relates to methods for determining and/or quantifying one or more analytes in fluids.

In one aspect, methods for quantifying an analyte in a fluid are provided. In some embodiments, a method comprises introducing or exposing a plurality of capture structures and a plurality of metal-containing particles to a fluid comprising the analyte such that the analyte binds with both a capture structure and a metal-containing particle to form a bound complex, wherein the plurality of metal-containing particles comprise a metal, separating any unbound metal-containing particles from the bound complex, exposing the bound complex to an electrolyte, applying an electric potential to oxidize at least a portion of the metal from the metal-containing particles, applying an electric potential to deposit at least a portion of the metal onto a working electrode, and measuring current by changing a voltage on the working electrode to determine the amount of analyte present in the fluid.

In some embodiments, prior to forming the bound complex, the plurality of metal-containing particles have an average particle size of at least 100 nm.

In some embodiments, the exposing step does not release the silver particle from the bound complex.

In some embodiments, prior to forming the bound complex, the plurality of metal-containing particles have an average particle size that is at least 0.06 times and less than or equal to 15 times an average particle size of the plurality of capture structures.

In some embodiments, a method comprises adding, to a sample comprising a plurality of analyte-containing biological particles, a buffer solution and a capture substrate such that at least a portion of the analyte-containing biological particles attach to the capture substrate, removing any components not attached to the capture substrate, exposing an analyte from the analyte-containing biological particles such that the analyte is available to form a bound complex, introducing, to the analyte, a plurality of capture structures and a plurality of metal-containing particles such that the analyte binds with both a capture structure and a metal-containing particle to form the bound complex, separating any unbound metal-containing particles from the bound complex, exposing the bound complex to an electrolyte, applying an electric potential to oxidize at least a portion of the metal from the metal-containing particles, applying an electric potential to deposit at least a portion of the metal onto a working electrode, and measuring current by changing a voltage on the working electrode to determine the amount of analyte present.

In some embodiments, a method comprises adding, to a sample comprising a plurality of analyte-containing biological particles, a lysing solution to expose an analyte from the analyte-containing biological particles such that the analyte is available to form a bound complex. The method involves introducing, to the analyte, a plurality of capture structures and a plurality of metal-containing particles such that the analyte binds with both a capture structure and a metal-containing particle to form the bound complex, separating any unbound metal-containing particles from the bound complex, and exposing the bound complex to an electrolyte. The method also involves applying an electric potential to oxidize at least a portion of the metal from the metal-containing particles, applying an electric potential to deposit at least a portion of the metal onto a working electrode, and measuring current by changing a voltage on the working electrode to determine the amount of analyte present.

In another aspect, methods for quantifying an analyte in a whole blood sample, are provided. In some embodiments, the method comprises introducing or exposing a plurality of capture structures and a plurality of metal-containing particles to a whole blood sample comprising an analyte such that the analyte binds with both a capture structure and a metal-containing particle to form a bound complex, wherein the metal-containing particles comprise a metal, separating any unbound metal-containing particles from the bound complex, exposing the bound complex to an electrolyte, applying an electric potential to oxidize at least a portion of the metal from the metal-containing particles, applying an electric potential to deposit at least a portion of the metal onto a working electrode, and measuring current by changing a voltage on the working electrode to determine the amount of analyte present.

In some embodiments of the methods described above and herein, the fluid comprises a blocking solution. In some embodiments, the blocking solution comprises BSA or casein.

In some embodiments of the methods described above and herein, the buffer solution comprises a chlorine-containing salt, metal acetate, and/or a salt selected from the group consisting of sodium acetate, zinc acetate, cooper acetate, NaCl, LiCl, CsCl, and combinations thereof. The buffer solution may comprise a salt having a concentration of 1 mM to 5 M. In some embodiments, the buffer solution has a pH from 4 to 10. In some embodiments, the buffer solution comprises 50 mM sodium acetate, at least 1 mM and less than or equal to 5 mM zinc acetate, and at least 50 mM and less than or equal to 200 mM sodium chloride.

In some embodiments of the methods described above and herein, the lysis solution comprises a detergent, a denaturant, a reducing agent, or combinations thereof. In some embodiments, the lysis solution comprises a detergent selected from the group consisting of anionic surfactants, zwitterionic surfactants, nonionic surfactants, and cationic surfactants.

In some embodiments of the methods described above and herein, the plurality of metal-containing particles have an average particle size of at least 100 nm. In some embodiments, the plurality of metal-containing particles have an average particle size of less than or equal to 2 microns. In some embodiments, the plurality of metal-containing particles are conjugated with a first antibody that can bind to the analyte. In some embodiments, the metal-containing particles comprise silver, cobalt, bismuth, cadmium, lead, zinc, tin, nickel, chromium, copper, or gold. The metal-containing particles may comprise a metal layer deposited on a non-metallic particle.

In some embodiments of the methods described above and herein, the plurality of capture structures have a mean cross-sectional dimension of at least 40 nm and less than or equal to 5 microns. The plurality of capture structures may comprise a magnetic material. In some embodiments, the plurality of capture structures are conjugated with a second antibody that can bind to the analyte. In some embodiments, the plurality of capture structures are not electrochemically active.

In some embodiments of the methods described above and herein, an average particle size of the plurality of silver particles is at least 0.2 times and less than or equal to 5 times an average particle size of the plurality of capture structures.

In some embodiments of the methods described above and herein, the concentration of the electrolyte is less than 1.0 M, less than 0.8 M, less than 0.6 M, less than 0.4 M, less than 0.2 M, or less than 0.1 M after adding the electrolyte to the fluid. In some embodiments, the electrolyte does not remove the silver particle from the bound complex upon introduction of the electrolyte. In some embodiments, at least 90%, at least 95%, or at least 99% of the silver particles in the bound complex are not removed from the bound complex upon introduction of the electrolyte.

In some embodiments of the methods described above and herein, applying the electric potential to oxidize at least a portion of the metal from the metal-containing particles directly oxidizes the plurality of silver particles from Ag⁰ to Ag⁺.

In some embodiments of the methods described above and herein, changing a voltage on the working electrode comprises increasing the electric potential to a voltage sufficient to oxidize the metal species present. In some embodiments, increasing the electric potential comprises increasing the voltage at a rate of at least 10 mV/s, 100 mV/s, or 1 V/s.

In some embodiments of the methods described above and herein, the plurality of metal-containing particles are directly oxidized with the applied potential without the use of an oxidizing agent.

In some embodiments of the methods described above and herein, the electrolyte undergoes an intermediate redox reaction.

In some embodiments of the methods described above and herein, the capture substrate non-specifically captures the virion.

In some embodiments of the methods described above and herein, the analyte-containing biological particle is a blood cell. In some embodiments, the analyte-containing biological particle is a virion, a bacterium, a protein complex, an exosome, a cell, or fungi.

In some embodiments of the methods described above and herein, the capture substrate is a plurality of beads. The plurality of beads may have an average diameters of between 40 nm and 5 microns. In some embodiments, the plurality of beads are magnetic. In some embodiments, the capture substrate is uncharged. In other embodiments, the capture substrate is charged.

In some embodiments of the methods described above and herein, prior to removing any components not bound to the capture substrate, the sample is mixed with the buffer solution for between 1-5 minutes.

In some embodiments of the methods described above and herein, the method comprises washing the capture substrate with a hypotonic solution.

In some embodiments of the methods described above and herein, the sample is a whole blood sample or plasma sample. In some embodiments, the fluid or sample is whole blood. In some embodiments, the fluid or sample is plasma.

In some embodiments of the methods described above and herein, the exposing step occurs prior to the step of introducing the plurality of capture structures and the plurality of metal-containing particles. In some embodiments, the exposing step occurs after the step of introducing the plurality of capture structures and the plurality of metal-containing particles. Exposing the analyte from the analyte-containing biological particles may comprise adding a lysing solution to release the analyte from the analyte-containing biological particles. In some embodiments, exposing the analyte from the analyte-containing biological particles comprises mechanical agitation or shearing.

In some embodiments of the methods described above and herein, removing any components not attached to the capture substrate comprises magnetic separation and/or washing.

In some embodiments of the methods described above and herein, the analyte is an antigen, a protein, a lipid, a glycolipid, nucleic acid, an amino acid, membrane protein (e.g., from a bacterium), a hormone, a small molecule, a metabolite, or a drug.

Other advantages and novel features of the present invention will become apparent from the following detailed description of various non-limiting embodiments of the invention when considered in conjunction with the accompanying figures. In cases where the present specification and a document Incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a process flow diagram of a method for determining an analyte, according to one set of embodiments;

FIG. 1B is a schematic illustration of a bound complex comprising a capture structure, a metal-containing particle, and an analyte, according to one set of embodiments;

FIG. 1C is a schematic drawing of a method for isolating an analyte-containing biological particle, according to one set of embodiments;

FIG. 1D is a plot demonstrating the efficiency of HCV virion capture from blood samples as measured by RT-PCR, according to one set of embodiments;

FIG. 1E is a plot demonstrating the cycle threshold from RT-PCT versus the concentration of virions in the sample, according to one set of embodiments;

FIGS. 2A-2C are schematic drawings of an exemplary method for determining and/or quantifying an analyte, according to some embodiments;

FIG. 2D is a plot of current versus voltage for various concentrations of HCV core antigen cAg, according to one set of embodiments;

FIGS. 2E-2F are plots of peak current area (μC) versus HCV core antigen concentration (pM), according to one set of embodiments;

FIG. 2G is a plot of peak current area (μC) for HCV clinical samples subjected to acid lysis, according to one set of embodiments;

FIG. 3 is a plot of peak current area (μC) versus concentration of HIV core antigen p24 (pM), according to one set of embodiments;

FIG. 4A is a plot of current versus voltage for various concentrations of HIV core antigen p24, according to one set of embodiments;

FIG. 4B is a plot of HIV core antigen p24 concentration (fM) versus peak current area (μC), according to one set of embodiments;

FIG. 5A is a plot of HIV core antigen p24 concentration (fM) versus peak current area (μC), according to one set of embodiments;

FIG. 5B is a plot of current versus voltage for various concentrations of HIV core antigen p24, according to one set of embodiments;

FIG. 6 is a plot of particle size versus peak current area (μC), according to one set of embodiments;

FIG. 7 is a plot of various HIV core antigen samples versus peak current area (μC), according to one set of embodiments;

FIGS. 8A-8B are plots of current versus voltage for (A) an NH₄SCN electrolyte and (B) a NaCl electrolyte, according to some embodiments;

FIG. 8C is a plot of release of a metal-containing particle in a NH₄SCN electrolyte and a NaCl electrolyte, according to one set of embodiments;

FIGS. 9A-9C are plots of electrolyte concentration versus peak current area (μC), for various concentrations of bound complexes; and

FIGS. 9D-9F are plots of current versus voltage for various concentrations of bound complexes.

### DETAILED DESCRIPTION

Methods for determining and/or quantifying one or more analytes in fluids are generally provided. In some embodiments, a method comprises introducing or exposing a plurality of capture structures (e.g., magnetic particles) and a plurality of metal-containing (e.g., silver) particles to a fluid comprising the analyte such that the analyte binds with both a capture structure and a metal-containing particle to form a bound complex. The bound complex may then be subjected to conditions (e.g., electrochemical conditions) that allow quantification of the analyte based on the amount of metal-containing particles present. The methods described herein may be useful for determining and quantifying relatively low concentrations of analytes present in a patient sample (e.g., a droplet of whole blood).

Advantageously, in some embodiments the methods described herein may permit the analysis of analytes from whole blood without additional filtering or separation steps, utilize materials and/or steps that do not require the release of the analyte from the bound complex, and/or have relatively high sensitivity as compared to certain existing analyte quantification methods. It should be appreciated, however, that in some embodiments, one or more of the methods may be performed and there may be other advantages associated with the method.

In some embodiments, a method involves determining and/or quantifying an analyte in a fluid suspected of containing the analyte. One step or series of steps may involve subjecting the fluid suspected of containing the analyte with capture structures (e.g., conjugated capture structures) and metal-containing particles (e.g., conjugated metal-containing particles) to form a bound complex. The analyte may be subjected to the capture structures and metal-containing particles in any suitable order. For instance, in some embodiments, the fluid suspected of containing the analyte is first exposed to the capture structures to form an analyte-capture structure complex. Such a complex may then be exposed to the metal-containing particles to form a bound metal-containing particle-analyte-capture structure complex. In other embodiments, the fluid suspected of containing the analyte is first exposed to the metal-containing particles to form an analyte-metal-containing particle complex. Such a complex may then be exposed to the capture structures to form a bound metal-containing particle-analyte-capture structure complex. In yet other embodiments, the fluid suspected of containing the analyte is exposed to a mixture of metal-containing particles and capture structures simultaneously.

As described herein a plurality of capture structures may be added to the fluid such that the analyte binds to at least a portion of the plurality of capture structures. The analyte may attach or bind to a capture structure in any suitable manner. In some cases, a single analyte (e.g., a single type of analyte, or a single number of analytes) attaches or binds to a single capture structure. In some embodiments, more than one analyte (e.g., more than one type of analyte, or more than one number of analytes) may attach or bind to a single capture structure. In certain embodiments, the analyte may attach or bind with the capture structure via formation of a non-specific bond (e.g., non-specific adsorption). In some cases, the analyte may interact with a functional group present on the surface of the capture structure. For example, the analyte may bind with the capture structure and/or a functional group present on the surface of the capture structure via a bond such as an ionic bond, a covalent bond (e.g., carbon-carbon, carbon-oxygen, oxygen-silicon, sulfur-sulfur, phosphorus-nitrogen, carbon-nitrogen, metal-oxygen, or other covalent bonds), a hydrogen bond (e.g., between hydroxyl, amine, carboxyl, thiol, and/or similar functional groups), a dative bond (e.g., complexation or chelation between metal ions and monodentate or multidentate ligands), and/or by Van der Waals interactions.

In some embodiments, the plurality of capture structures comprise a plurality of particles. The plurality of capture structures may have any suitable average particle size. Although other sizes are possible, in some cases the average particle size of the capture structures is relatively large (e.g., at least 100 nm, at least 200 nm) to facilitate manipulation of the particles by an external magnetic field. Average particle size as used herein generally refers to the median (D50) diameter of the particles and is determined by dynamic light scattering, for example using a Malvern Particle Size Analyzer. Dynamic light scattering techniques will be generally known to those skilled in the art.

In certain embodiments, the plurality of capture structures (e.g., capture structure) have an average particle size of at least 40 nm, at least 50 nm, at least 60 nm, at least 70 nm, at least 80 nm, at least 90 nm, at least 100 nm, at least 200 nm, at least 250 nm, at least 300 nm, at least 400 nm, at least 500 nm, at least 600 nm, at least 700 nm, at least 800 nm, at least 900 nm, at least 1 micron, or at least 1.5 microns. In some embodiments, the plurality of capture structures have an average particle size of less than or equal to 5 microns, less than or equal to 2 microns, less than or equal to 1.5 microns, less than or equal to 1 micron, less than or equal to 900 nm, less than or equal to 800 nm, less than or equal to 700 nm, less than or equal to 600 nm, less than or equal to 500 nm, less than or equal to 400 nm, less than or equal to 300 nm, less than or equal to 250 nm, less than or equal to 200 nm, less than or equal to 150 nm, less than or equal to 100 nm, or less than or equal to 50 nm. Combinations of the above reference ranges are also possible (e.g., at least 200 nm and less than or equal to 5 microns, at least 40 nm and less than or equal to 1 micron). Other ranges are also possible. The average particle size of the capture structures may be measured prior to forming a complex with the analyte (e.g., a capture structure-analyte complex). In some embodiments, the average particle size of the capture structures may be measured prior to exposing the particles to the electrolyte used in a detection step.

In some embodiments, the plurality of capture structures are a plurality of magnetic particles. The plurality of magnetic particles may comprise any suitable magnetic (or magnetizable) material. In certain embodiments, the magnetic material comprises a ferromagnetic material. Non-limiting examples of suitable magnetic materials include iron, nickel, cobalt, and alloys thereof and combinations thereof. In some embodiments, the plurality of capture structures are not electrochemically active (in the environment in which the particles are positioned). For example, in certain embodiments, the plurality of magnetic particles comprise a magnetic material which does not exchange electrons with conductive surfaces such as electrodes.

Advantageously, analytes bound to capture structures comprising a magnetic material may allow the use of a magnetic field to direct, separate, and/or isolate the analyte in the fluid (e.g., via use of an external magnet located proximate to, or in direct contact with, the fluid or a container containing the fluid). For example, in some embodiments, a magnet may be placed on an external surface of a container containing the fluid comprising the analyte bound to capture structure(s) such that the analyte bound to capture structures is attracted to and moves towards (or away from) the magnet.

In certain embodiments, the methods described herein can be performed in a fluidic device such as a microfluidic device. In some such embodiments, the plurality of capture substrates may include a portion of a surface of the fluidic device, such as a surface of a channel. In some embodiments, the plurality of capture substrates are areas on a surface of a channel that have been functionalized with a capture entity. In certain embodiments, the plurality of capture structures comprise a plurality of microfluidic posts. For example, in some embodiments, a microfluidic device comprises a plurality of microfluidic posts (e.g., conjugated microfluidic posts), such that an analyte introduced into the microfluidic device binds to the plurality of microfluidic posts. In some such embodiments, a plurality of metal-containing particles may then be added to the microfluidic device such that the metal-containing particle, analyte, and microfluidic post forms a bound complex. Those skilled in the art would be capable of selecting suitable microfluidic devices and structures (e.g., posts) based upon the teachings of this specification.

Additional non-limiting examples of suitable capture structures include woven pads, non-woven pads, polymeric packing (e.g., polystyrene-divinylbenzene), fibers such as microfibers (e.g., electrospun microfibers) and nanofibers, particles, and petri dish surfaces (e.g., at least a portion of a surface of a petri dish, multi-well plate, or the like). Other capture structures are also possible.

In some embodiments, the plurality of capture structures are coated with one or more materials. Non-limiting examples of suitable materials may include polymers, silica, proteins (e.g., protein G conjugated, streptavidin conjugated, BSA conjugated), and materials with specific functional groups. Non-limiting examples of functional groups include hydroxyl, amino, carboxylate, carbonyl, ether, ester, sulfhydryl (thiol), silane, nitrile, carbamate, imidazole, pyrrolidone, carbonate, acrylate, alkenyl, and alkynyl)). Other functional groups are also possible and are known to those skilled in the art.

In some embodiments, a plurality of metal-containing particles may be added to the fluid such that the analyte attaches or binds to at least a portion of the plurality of metal-containing particles. The analyte may attach or bind to a metal-containing particle in any suitable manner. In some cases, a single analyte (e.g., a single type of analyte, or a single number of analyte) attaches or binds to a single metal-containing particle. In some embodiments, more than one analyte (e.g., more than one type of analyte, or more than one number of analytes) may attach or bind to a single metal-containing particle. In certain embodiments, the analyte may attach or bind with the metal-containing particle via formation of a non-specific bond (e.g., non-specific adsorption). In some cases, the analyte may interact with a functional group present on the surface of the metal-containing particle. For example, the analyte may bind with the metal-containing particle and/or a functional group present on the surface of the metal-containing particle via a bond such as an ionic bond, a covalent bond (e.g., carbon-carbon, carbon-oxygen, oxygen-silicon, sulfur-sulfur, phosphorus-nitrogen, carbon-nitrogen, metal-oxygen, or other covalent bonds), a hydrogen bond (e.g., between hydroxyl, amine, carboxyl, thiol, and/or similar functional groups), a dative bond (e.g., complexation or chelation between metal ions and monodentate or multidentate ligands), and/or by Van der Waals interactions.

The plurality of metal-containing particles may have any suitable average particle size. Although other sizes are possible, in some cases the average particle size of the metal-containing particles is relatively large (e.g., at least 100 nm, at least 200 nm) to increase the signal-to-noise ratio when using certain detection methods, as described in more detail below. In certain embodiments, the plurality of metal-containing particles have an average particle size of at least 70 nm, at least 100 nm, at least 150 nm, at least 200 nm, at least 250 nm, at least 300 nm, at least 400 nm, at least 500 nm, at least 600 nm, at least 700 nm, at least 800 nm, at least 900 nm, at least 1 micron, or at least 1.5 microns. In some embodiments, the plurality of metal-containing particles have an average particle size of less than or equal to 2 microns, less than or equal to 1.5 micron, less than or equal to 1 micron, less than or equal to 900 nm, less than or equal to 800 nm, less than or equal to 700 nm, less than or equal to 600 nm, less than or equal to 500 nm, less than or equal to 400 nm, less than or equal to 300 nm, less than or equal to 250 nm, less than or equal to 200 nm, less than or equal to 150 nm, or less than or equal to 100 nm. Combinations of the above-referenced ranges are also possible (e.g., at least 200 nm and less than or equal to 2 microns). Other ranges are also possible. The average particle size of the metal-containing particles may be measured prior to forming a complex with the analyte (e.g., a metal-containing particle-analyte complex). In some embodiments, the average particle size of the metal-containing particles may be measured prior to exposing the particles to the electrolyte used in a detection step.

In certain embodiments, the plurality of metal-containing particles have an average particle size that is within a particular range of the average particle size of the plurality of capture structures. For example, in some embodiments, the plurality of metal-containing particles have an average particle size that is at least 0.05, at least 0.06, at least 0.07, at least 0.08, at least 0.1, at least 0.15, at least 0.2, at least 0.5, at least 0.8, at least 1, at least 2, at least 2.5, at least 3, at least 4, or at least 5 times the average particle size of the plurality of capture structures. In certain embodiments, the plurality of metal-containing particles have an average particle size that is less than or equal to 20, less than or equal to 18, less than or equal to 16, less than or equal to 15, less than or equal to 14, less than or equal to 12, less than or equal to 10, less than or equal to 8, less than or equal to 6, less than or equal to 5, less than or equal to 4, less than or equal to 3, less than or equal to 2.5, less than or equal to 2, less than or equal to 1, less than or equal to 0.8, less than or equal to 0.5, less than or equal to 0.2, less than or equal to 0.15, less than or equal to 0.1, less than or equal to 0.08, or less than or equal to 0.07 times the average particle size of the plurality of capture structures. Combinations of the above-referenced ranges are also possible (e.g., at least 0.06 and less than or equal to 15 times, at least 0.06 and less than or equal to 6 times, at least 0.07 and less than or equal to 2 times, at least 0.2 and less than or equal to 2.5 times, at least 1 and less than or equal to 4 times, at least 2 and less than or equal to 6 times the average particle size of the plurality of capture structures). Other ranges are also possible. The average particle sizes used may be those prior to forming a complex with the analyte (e.g., a capture structure-analyte-metal-containing particle complex). In some embodiments, the average particle sizes may be those prior to exposure of the particles to the electrolyte used in a detection step.

In some embodiments, a plurality of capture substrates (e.g., magnetic particles) that are larger (e.g., at least 2 times the average particle size) than a plurality of metal-containing particles may permit the separation of a bound complex from unbound complexes by size. For example, in certain embodiments, bound complexes may be separated from unbound complexes by size sorting techniques including, but not limited to, membrane separation, size exclusion chromatography, and centrifugation. Other size sorting and/or separation techniques are also possible.

The average particle size of the metal-containing particle and/or the average particle size of the capture structure may be chosen based on a balance of factors such as increasing the amplification of the signal during a detection step (e.g., quantification), improving the efficiency of forming bound complexes with the metal-containing particle, the capture structure, and the analyte, and/or more easily removing unbound particles from the fluid (e.g., when isolating bound complexes with a magnet, separating the bound complexes via size exclusion chromatography, centrifugation, or membrane separation). Without wishing to be bound by theory, in certain embodiments, larger metal-containing particles generally lead to greater amplification of the signal during quantification using certain detection methods described herein, whereas smaller metal-containing particles (and/or capture structures) generally lead to improved ability of binding between the analyte and the metal-containing particle and the capture structure. For instance, smaller particles generally lead to a reduced amount of steric hindrance during binding with the analyte. Additionally, larger capture structures generally have a higher magnetic moment and thus are more easily moved by a magnet in the fluid (e.g., to remove unbound components).

As described herein, in some embodiments, relatively large metal-containing particles may be used. Advantageously, relatively larger metal-containing particles may result in an increased amplification of the signal during detection, which may increase the sensitivity of the methods described herein as compared to traditional quantification methods, which utilize relatively smaller (e.g., less than 40 nm) metal-containing particles.

The metal-containing particles may comprise any suitable metal that may be useful for detecting an analyte present in the fluid. In some cases, the metal is one that can be oxidized and/or reduced in the presence of one or more electrodes. Non-limiting examples of such suitable metals include silver, cobalt, cadmium, copper, lead, zinc, tin, bismuth, nickel, chromium, and gold. In a particular embodiment, the metal-containing particles comprise silver. In some embodiments, the metal is present as a layer on a nonmetallic particle. For example, in certain embodiments, at least a portion of a surface of a nonmetallic particle is coated with the metal. Non-limiting examples of suitable nonmetallic particles include polymers, silica, or the like. In other embodiments, the core of the metal-containing particle may be formed of the metal. In such embodiments, the surface of the metal-containing particle may be modified to tailor the surface chemistry of the particle as described herein.

In some embodiments, the plurality of capture structures and the plurality of metal-containing particles may be simultaneously introduced to the fluid comprising the analyte. In some cases, however, the plurality of capture structures may be added sequentially (e.g., prior to, or after) the introduction of the plurality of metal-containing particles to the fluid comprising analyte. In some embodiments, the plurality of capture structures may be added to the fluid and incubated and/or mixed for any suitable amount of time such that at least a portion of the plurality of capture structures attach or bind to the analyte. For example, the plurality of capture structures and analyte may be incubated and/or mixed for at least 1 minute, at least 2 minutes, at least 3 minutes, or at least 4 minutes such that at least a portion of the plurality capture structures attach or bind to the analyte. In certain embodiments, the plurality of capture structures and analyte may be incubated and/or mixed for less than or equal to 10 minutes, less than or equal to 5 minutes, less than or equal to 4 minutes, less than or equal to 3 minutes, or less than or equal to 2 minutes such that at least a portion of the plurality of capture structures attach or bind the analyte. Combinations of the above referenced ranges are also possible (e.g. at least 1 minute and less than or equal to 5 minutes). Other ranges are also possible. In some other embodiments, the plurality of capture structures and analyte may be incubated for more than 5 minutes.

In certain embodiments, the metal-containing particles may be added to the fluid and incubated and/or mixed for any suitable amount of time such that at least a portion of the plurality of metal-containing particles attach or bind to the analyte. For example, the plurality of metal-containing particles and analyte may be incubated and/or mixed for at least 1 minute, at least 2 minutes, at least 3 minutes, or at least 4 minutes such that at least a portion of the plurality metal-containing particles attach or bind to the analyte. In certain embodiments, the plurality of metal-containing particles and analyte may be incubated and/or mixed for less than or equal to 10 minutes, less than or equal to 5 minutes, less than or equal to 4 minutes, less than or equal to 3 minutes, or less than or equal to 2 minutes such that at least a portion of the plurality of metal-containing particles bind the analyte. Combinations of the above referenced ranges are also possible (e.g. at least 1 minute and less than or equal to 5 minutes). Other ranges are also possible. In some other embodiments, the plurality of metal-containing particles and analyte may be incubated for more than 5 minutes.

In some embodiments, the plurality of capture structures and the plurality of metal-containing particles are incubated and/or mixed with the analyte substantially simultaneously. In certain embodiments, the plurality of capture structures are incubated and/or mixed with the analyte prior to incubating and/or mixing the plurality of metal-containing particles with the analyte.

In certain embodiments, the plurality of capture structures and/or the plurality of metal-containing particles are incubated and/or mixed with the analyte in a buffer solution or an electrolyte. That is to say, in certain embodiments, a buffer solution or an electrolyte may be added to the metal-containing particles, the capture structures, and/or the fluid comprising analyte. For example, the fluid may be mixed with the buffer solution or an electrolyte for any suitable amount of time (e.g., at least 1 minute and less than or equal to 5 minutes). Buffer solutions and electrolytes are described in more detail below.

The capture structure and/or metal-containing particle may each interact with an analyte via a binding event between pairs of biological molecules (e.g., a biological molecule present on the surface of the capture structure and/or metal-containing particle and the analyte), including proteins, nucleic acids, glycoproteins, carbohydrates, hormones, and the like. Specific examples include an antibody/peptide pair, an antibody/antigen pair, an antibody fragment/antigen pair, an antibody/antigen fragment pair, an antibody fragment/antigen fragment pair, an antibody/hapten pair, an enzyme/substrate pair, an enzyme/inhibitor pair, an enzyme/cofactor pair, a protein/substrate pair, a nucleic acid/nucleic acid pair, a protein/nucleic acid pair, a peptide/peptide pair, a protein/protein pair, a small molecule/protein pair, a glutathione/GST pair, an anti-GFP/GFP fusion protein pair, a Myc/Max pair, a maltose/maltose binding protein pair, a carbohydrate/protein pair, a carbohydrate derivative/protein pair, a metal binding tag/metal/chelate, a peptide tag/metal ion-metal chelate pair, a peptide/NTA pair, a lectin/carbohydrate pair, a receptor/hormone pair, a receptor/effector pair, a complementary nucleic acid/nucleic acid pair, a ligand/cell surface receptor pair, a virus/ligand pair, a Protein A/antibody pair, a Protein G/antibody pair, a Protein L/antibody pair, an Fc receptor/antibody pair, a biotin/avidin pair, a biotin/streptavidin pair, a drug/target pair, a zinc finger/nucleic acid pair, a small molecule/peptide pair, a small molecule/protein pair, a small molecule/target pair, a carbohydrate/protein pair such as maltose/MBP (maltose binding protein), a small molecule/target pair, or a metal ion/chelating agent pair. Specific non-limiting examples of species include peptides, proteins, DNA, RNA, PNA.

In some embodiments, the capture structure may interact with an analyte via a first type of binding event between a pair of biological molecules and the metal-containing particle may interact with the analyte via a second type of binding event between a pair of biological molecules, different than the first binding event.

For instance, in some embodiments, the plurality of capture structures may be conjugated with a biological molecule or functional group, and/or the plurality of metal-containing particles may be conjugated with a biological molecule or functional group. In some embodiments, the plurality of capture structures and/or the plurality of metal-containing particles are conjugated with one or more antibodies. In certain embodiments, the capture structure may interact with the analyte via a first antibody/antigen interaction and the metal-containing particle may interact with the analyte via a second antibody/antigen interaction, different than the first antibody/antigen interaction. For example, the capture structure may interact with the analyte at a first binding site on the analyte (e.g. a first epitope) and the metal-containing particle may interact with the analyte at a second binding site on the analyte (e.g., a second epitope), different than the first binding site, on the analyte. Other interactions and/or binding events between pairs of biological molecules are also possible.

In certain embodiments, the analyte is a protein, an indigent, a lipid, a glycolipid, nucleic acid, an amino acid, membrane protein (e.g., from a bacterium), a hormone, a small molecule, a metabolite, a drug, or the like.

In certain embodiments, the analyte is an antigen (e.g., an antigen for the hepatitis C virion (HCV), or an antigen for HIV). Non-limiting examples of HCV antigens include antigens such as E1, E2, NS2, NS3, NS4 (e.g., NS4A, NS4B), and NS5 (e.g., NS5A, and NS5B). In an exemplary embodiment, the analyte is a core antigen. Non-limiting examples of core antigens which may be determined and/or quantified using methods described herein include HIV core antigen p24 and HCV core antigen (cAg). In some embodiments, a combination of HCV core antigen and one or more of the HCV antigens listed above may be determined.

In some embodiments, the analyte is a protein (e.g., a cardiac marker such as Troponin I). In certain embodiments, the protein is a protein found circulating free in blood or in a complex in blood. In an exemplary embodiment, the protein is a cardiac marker protein such as creatine kinase-MB (CK-MB), myoglobin, homocysteine, C-reactive protein (CRP), troponin T, or troponin I. In some embodiments, they analyte is a hormone or small molecule used for diagnosis of endocrine disfunction, such as thyroid-stimulating hormone (TSH), triiodothyronine (T3), thyroxine (T4), or Vitamin D.

In certain embodiments, the plurality of capture structures and/or the plurality of metal-containing particles may interact and bind with one or more analytes (e.g., two or more, three or more, four or more, or five or more analytes), such as one or more antigens. In some embodiments, the plurality of capture structures and/or the plurality of metal-containing particles are conjugated with one or more antibodies and capable of binding to one or more analytes (e.g., one or more antigens). For example, in some cases, the plurality of capture structures and/or the plurality of metal-containing particles may interact and bind with a core antigen and one or more additional antigens. In such embodiments, the capture structures and/or metal-containing particles may include more than one type of antibody that bind to different antigens. In an exemplary embodiment, the plurality of capture structures are conjugated with a first antibody and a second antibody, and the plurality of metal-containing particles are conjugated with a third antibody and a fourth antibody, such that the first antibody and the third antibody form a bound complex with a first antigen (e.g., a core antigen), and the second antibody and the fourth antibody each bind with a second antigen (e.g., a non-core antigen). For example, in some cases, the first antibody and the third antibody form a bound complex with cAg and the second antibody and the fourth antibody each bind to at least one additional HCV antigen. In some cases, the second antibody and the fourth antibody form a second bound complex. Accordingly, the plurality of capture structures and/or the plurality of metal-containing particles may be conjugated with a plurality of antibodies capable of binding to a plurality of analytes (e.g., antigens). In an exemplary embodiment, the antibody is an HIV-p24 antibody (e.g., commercial available from ZeptoMetrix™ such as anti-HIV-I p24, Clone: 39/5.4A). In another exemplary embodiment, the antibody is an HCV core antigen antibody (e.g., commercially available from Capricorn such as HCV-007-48489, HCV-007-48490, and HCV-007-48491).

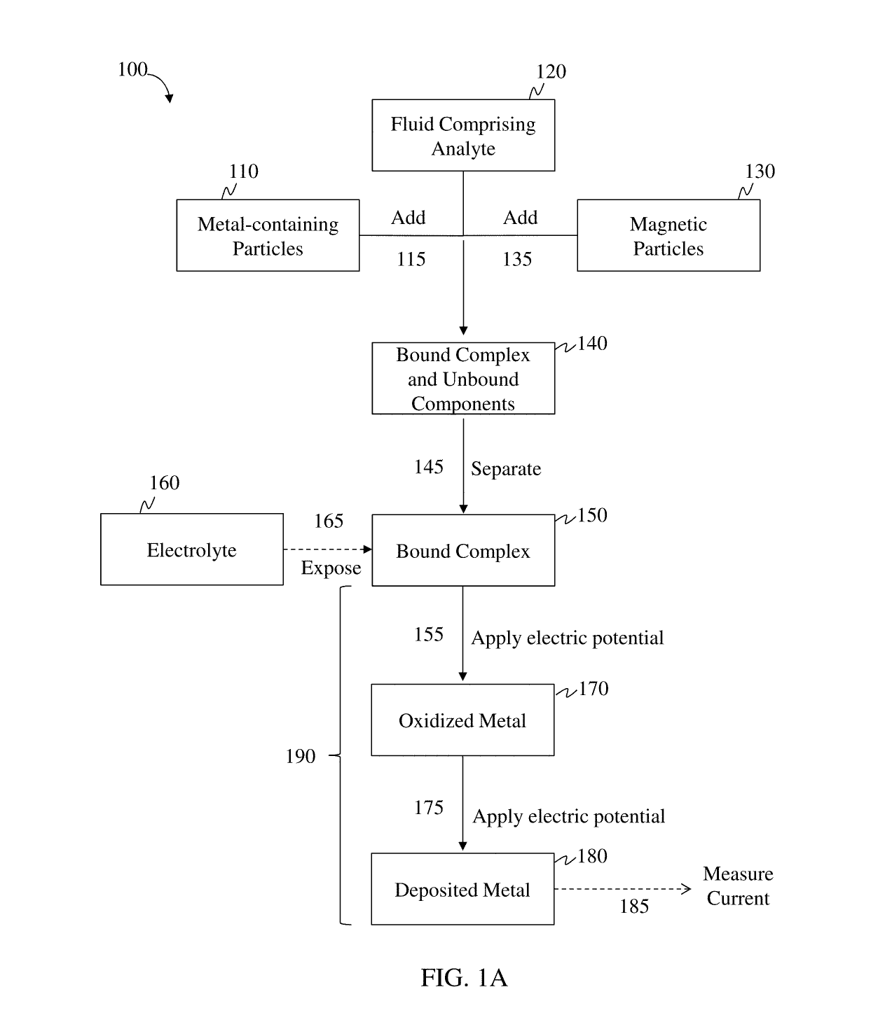

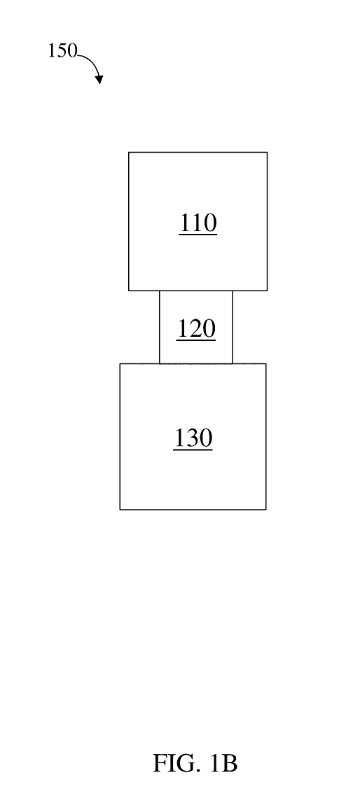

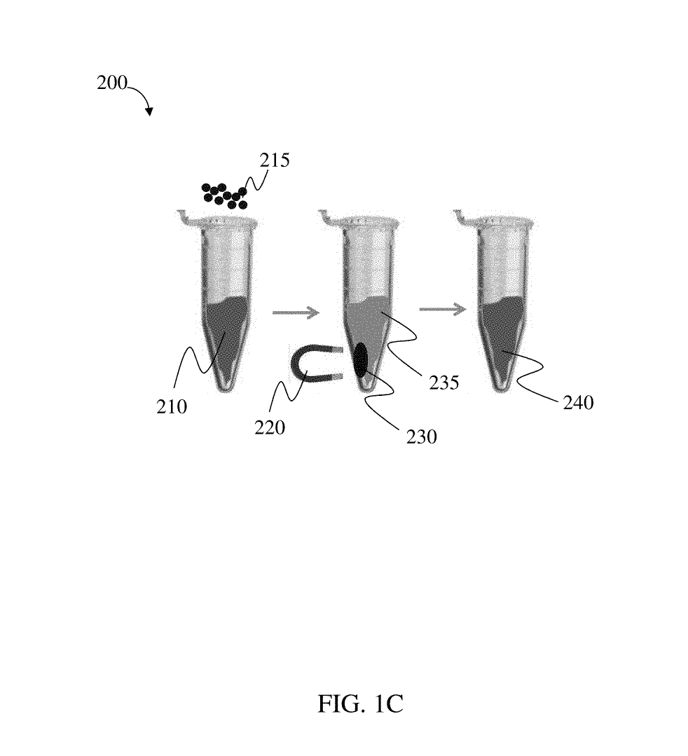

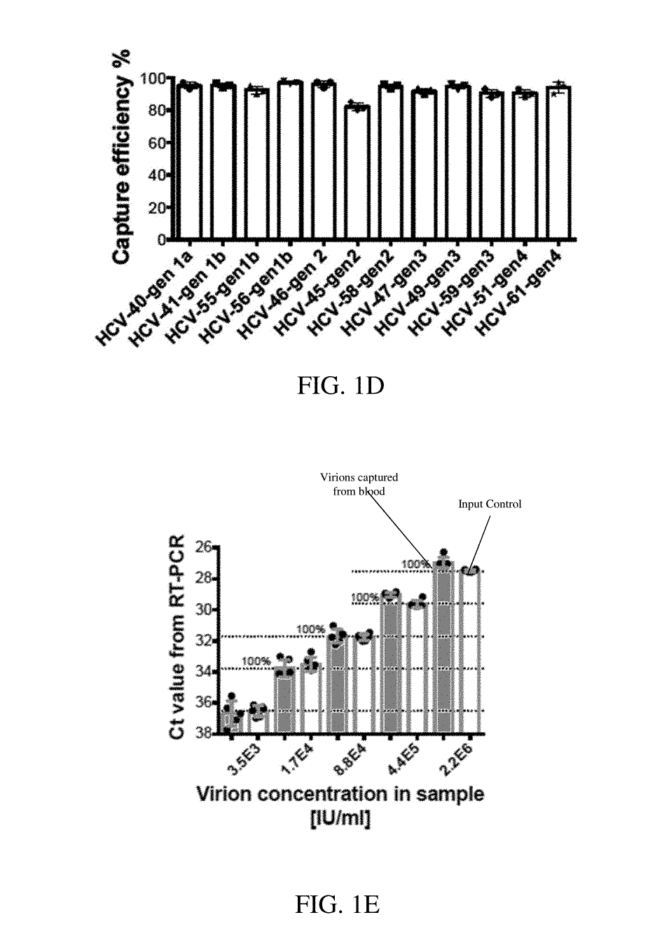

Referring now to FIG. 1A, in some embodiments, a method 100 for quantifying and/or determining an analyte may include one or more adding steps, a separation step, an exposure step, and/or one or more application of electric potential steps, amongst others. For instance, a plurality of metal-containing particles 110 may be added in step 115 and a plurality of capture structures 130 may be added in step 135 to a fluid comprising an analyte 120. In some embodiments, adding step 115 and adding step 135 may take place substantially simultaneously, or the metal-containing particles and capture structures may be initially present in a single fluid. In certain embodiments, however, adding step 115 and adding step 135 may occur at different times, as described above.

In some embodiments, the analyte binds with a metal-containing particle and a capture structure to form a bound complex comprising the metal-containing particle, the capture structure, and the analyte. An exemplary bound complex 150 is shown illustratively in FIG. 1B. In FIG. 1B, bound complex 150 comprises a metal-containing particle 110 bound to analyte 120, and a capture structure 130 bound to the analyte. Those skilled in the art would understand that while a single analyte is shown, more than one analyte may be bound to a capture structure and/or a metal-containing particle simultaneously. Referring again to FIG. 1A, in some embodiments, adding plurality of capture structures 130 and metal-containing particles 110 to a fluid comprising an analyte 120 forms a mixture of bound complexes and unbound components 140. The unbound components, in some embodiments, may comprise a portion of the capture structures not bound to the analyte, a portion of the metal-containing particles not bound to the analyte, and/or other components present in the fluid comprising the analyte.

In some embodiments, the capture structures may be introduced to the fluid comprising the analyte in a particular amount. In some embodiments, the capture structure may be introduced to the fluid in an amount of at least 5 μg/100 μL, at least 10 μg/100 μL, at least 25 μg/100 μL, at least 50 μg/100 μL, at least 100 μg/100 μL, or at least 250 μg/100 μL. In certain embodiments, the capture structure may be introduced to the fluid in an amount of less than or equal to 500 μg/100 μL, less than or equal to 250 μg/100 μL, less than or equal to 100 μg/100 μL, less than or equal to 50 μg/100 μL, less than or equal to 25 μg/100 μL, or less than or equal to 10 μg/100 μL. Combinations of the above referenced ranges are also possible (e.g., at least 5 μg/100 μL and less than or equal to 500 μg/100 μL). Other ranges are also possible.

In some embodiments, the metal-containing particles may be introduced to the fluid comprising the analyte in a particular amount. In some embodiments, the metal-containing particles may be introduced to the fluid in an amount of at least 5 μg/100 μL, at least 10 μg/100 μL, at least 25 μg/100 μL, at least 50 μg/100 μL, at least 100 μg/100 μL, or at least 250 μg/100 μL. In certain embodiments, the metal-containing particles may be introduced to the fluid in an amount of less than or equal to 500 μg/100 μL, less than or equal to 250 μg/100 μL, less than or equal to 100 μg/100 μL, less than or equal to 50 μg/100 μL, less than or equal to 25 μg/100 μL, or less than or equal to 10 μg/100 μL. Combinations of the above referenced ranges are also possible (e.g., at least 5 μg/100 μL and less than or equal to 500 μg/100 μL).

In certain embodiments, method 100 comprises separating, via separating step 145, any unbound components from the bound complex. Advantageously, the methods described herein can be used to quantify analytes present in a fluid such as whole blood. Whole blood is generally challenging to analyze with traditional qualification methods without additional filtration, separation, and/or dilution steps, since such steps may, for example, inadvertently remove and/or damage the analyte. In some embodiments, the capture structure comprises a magnetic particle and a magnetic field and/or magnet may be applied to the mixture of bound complexes and unbound components 140 such that the bound complexes comprising the capture structure are attracted to, and move towards, the magnet and/or magnetic field. In some such embodiments, the unbound components then may be separated (e.g., via aspiration and/or removal of the supernatant comprising the unbound components) from the bound complexes. While magnet induced separation is described herein, those skilled in the art would be capable of selecting other suitable methods (e.g., centrifugation, size exclusion chromatography) for separating bound complexes from unbound components based upon the teachings of this specification in methods known in the art. In some embodiments, the separating step comprises separating any unbound metal-containing particles from the bound complex. In some cases, the separating step produces a plurality of bound complexes 150 with substantially no unbound metal-containing particles (e.g., less than 5 wt %, less than 2 wt %, less than 1 wt %, less than 0.5 wt %, less than 0.1 wt % unbound metal-containing particles versus the total bound complex weight). The weight percent of unbound metal-containing particles may be determined, for example, by collecting the fluid not including the bound complex and performing dynamic light scattering to quantify the concentration of unbound metal-containing particles in the collected fluid.

In some embodiments, the method comprises exposing the bound complex to an electrolyte (e.g., an electrolyte that may facilitate detection of the analyte). In some embodiments, the exposing step does not release the analyte from the metal-containing particle and/or the capture structure. Referring again to FIG. 1A, in some instances, bound complex 150 may undergo exposing step 165. In certain embodiments, the exposing step comprises exposing bound complex 150 to electrolyte 160, e.g., by adding the electrolyte to a fluid containing the bound complexes. In some cases, exposing step 165 may occur simultaneously with adding step 115 and/or adding step 135. That is to say, in some embodiments, the electrolyte 160 may be added to, or initially present in, the fluid comprising the analyte 120, prior to separating step 145. In other embodiments, the electrolyte may be added to, or initially present in, the fluid comprising the metal-containing particles and/or comprising the capture structures. In some cases, electrolyte 160 may be added to the mixture comprising the bound complex and unbound components 140. In certain embodiments, bound complex 150 may be exposed to electrolyte 160 after separating step 145.

As described herein, the electrolyte may facilitate detection of the analyte. In some cases, the electrolyte is used to conduct ions across electrodes in an electrochemical detection method, as described in more detail below. In some embodiments, the electrolyte does not remove the metal-containing particle from the bound complex upon introduction of the electrolyte to the bound complex. In certain embodiments, at least 90%, at least 95%, at 98%, or at least 99% of the metal-containing particles are not removed from the bound complex upon introduction of the electrolyte.

In some embodiments, the electrolyte comprises a halide compound (e.g., NaCl, KCl, NaBr, KI). In certain embodiments, the electrolyte comprises a thiocyanate (e.g., ammonium thiocyanate). In some embodiments, the electrolyte comprises an oligoelectrolyte or polyelectrolyte. Polyelectrolytes are known in the art and generally refer to polymers with a repeat unit comprising an electrolyte group. Non-limiting examples of polyelectrolytes include poly(sodium styrene sulfonate), polypeptides, glycosaminoglycans, DNA, and polyacids (e.g., polyacrylic acid). In certain embodiments, the electrolyte comprises a salt.

Simple screening tests can be employed to help select an electrolyte. One simple screen test includes incubating the bound complex with the electrolyte for five minutes and then removing the electrolyte. The amount of metal-containing particles bound in the bound complex can be measured using anodic stripping voltammetry and compared to the amount of metal-containing particles present in the removed electrolyte measured by anodic stripping voltammetry.

In some embodiments, the bound complex is exposed to the electrolyte at a particular concentration. In certain embodiments, the concentration of the electrolyte in the fluid containing the bound complex is less than 1.0 M, less than 0.8 M, less than 0.6 M, less than 0.4 M, less than 0.2 M, or less than 0.1 M. In some embodiments, the concentration electrolyte is greater than or equal to 0.01 M, greater than or equal to 0.05 M, greater than or equal to 0.1 M, greater than or equal to 0.2 M, greater than or equal to 0.4 M, greater than or equal to 0.6 M, or greater than or equal to 0.8 M. Combinations of the above referenced ranges are also possible (e.g., less than 1.0 M in greater than or equal to 0.01 M). Other ranges are also possible.

In certain embodiments, the method comprises determining the amount of analyte present in the fluid. Referring again to FIG. 1A, method 100 comprises determining step 190. The determining step may comprise any suitable method for quantifying the amount of analyte present in the fluid. In some cases, the determining step involves quantifying (e.g., directly or indirectly) the amount of metal-containing particles in the bound complex. Without wishing to be bound by theory, the amount of metal-containing particles in the bound complex is proportional (e.g., directly related) to the amount of analyte present in the fluid. In some cases, the metal-containing particles are functionalized with an antibody that specifically binds to an analyte, such that the determining step determines the amount of analyte bound to the metal-containing particle. For example, in some embodiments, the determining step comprises voltammetry, including but not limited to, anodic stripping voltammetry, cathodic stripping voltammetry, adsorptive stripping voltammetry, square wave voltammetry, linear sweep voltammetry, staircase voltammetry, cyclic voltammetry, alternating current voltammetry, chronoamperometry, normal pulse voltammetry, differential-pulse voltammetry, or the like. These methods may be used to quantify the amount of metal-containing particles present, thereby quantifying the amount of analyte present in the fluid as described in more detail below.

In some cases, determining step 190 comprises the application of one or more electric potentials to bound complex 150. Referring again to FIG. 1A, method 100 comprises determining step 190, comprising applying one or more electric potentials (e.g., electric potential application step 155 and electric potential application step 175). Those skilled in the art would be capable of selecting suitable methods for applying electric potential to the bound complexes including, but not limited to, providing a working electrode proximate to or in direct contact with at least a portion of the bound complex and an auxiliary electrode, such that an electric potential can be applied to the bound complex. In certain embodiments, electric potential application step 155 comprises applying an electric potential such that at least a portion of the metal from the metal-containing particles is oxidized, forming oxidized metal 170. In some such embodiments, electric potential application step 175 comprises applying an electric potential to oxidized metal 170 such that at least a portion of the metal is deposited onto a working electrode (e.g., a working in contact with at least a portion of the bound complex), forming deposited metal layer 180 on the working electrode (e.g., via a reduction step).

The one or more electric potentials may be each applied for any suitable amount of time. In some embodiments, the one or more electric potentials may each be applied for at least 1 second, at least 5 seconds, at least 10 seconds, at least 15 seconds, at least 30 seconds, at least 45 seconds, at least 60 seconds, at least 2 minutes, at least 4 minutes, at least 5 minutes, at least 10 minutes, at least 15 minutes, or at least 30 minutes. In certain embodiments, the one or more electric potentials may each be applied for less than or equal to 60 minutes, less than or equal to 30 minutes, less than or equal to 15 minutes, less than or equal to 10 minutes, less than or equal to 5 minutes, less than or equal to 4 minutes, less than or equal to 2 minutes, less than or equal to 60 seconds, less than or equal to 45 seconds, less than or equal to 30 seconds, less than or equal to 15 seconds, less than or equal to 10 seconds, or less than or equal to 5 seconds. Combinations of the above referenced ranges are also possible (e.g., at least one second and less than or equal to 60 minutes, at least 15 seconds and less than or equal to 2 minutes, at least 30 seconds and less than or equal to 5 minutes, at least 1 minute and less than or equal to 10 minutes, at least 5 minutes and less than or equal to 30 minutes, at least 15 minutes and less than or equal to 60 minutes). Other ranges are also possible.

In some embodiments, a positive electric potential (e.g., electric potential application step 155) is applied such that at least a portion of the metal present in the metal-containing particles is oxidized. In certain embodiments, the plurality of metal-containing particles are directly oxidized with the applied electric potential without the use of an oxidizing agent. In some cases, the metal-containing particles comprise silver and the positive electric potential may directly oxidize the silver from Ag0 to Ag+.

In some embodiments, the positive electric potential may be at least 0 V, at least 0.1V, at least 0.2 V, at least 0.5 V, at least 1 V, at least 1.2 V, at least 1.5 V, or at least 1.7 V. In certain embodiments, the positive electric potential may be less than or equal to 2 V, less than or equal to 1.7 V, less than or equal to 1.5 V, less than or equal to 1.2 V, less than or equal to 1 V, less than or equal to 0.5 V, less than or equal to 0.2 V, or less than or equal to 0.1 V. Combinations of the above referenced ranges are also possible (e.g., at least 0V and less than or equal to 2V). Other ranges are also possible. Those skilled in the art would understand that the magnitude the positive electric potential may depend, at least in some part, on the electrode material (e.g., the reference electrode material, the working electrode material) and would be capable of selecting a suitable range of electric potentials based upon the teachings of this specification. For example, in some embodiments the reference electrode comprises a carbon material and the positive electric potential may be selected to be at least 0V and less than or equal to 2V. In some embodiments, the range of voltage is sufficient to oxidize a metal species present.

In certain embodiments, a negative electric potential (e.g., electric potential application step 175) is applied such that at least a portion of the oxidized metal (e.g., metal from the metal-containing particles) is deposited onto the working electrode. In certain embodiments, the negative electric potential is less than or equal to −0.1V, less than or equal to −0.2 V, less than or equal to −0.5 V, less than or equal to −0.7 V, less than or equal to −1 V, less than or equal to −1.2 V, less than or equal to −1.5 V, or less than or equal to −1.7 V. In some embodiments, the negative electric potential is greater than or equal to −2.0 V, greater than or equal to −1.7 V, greater than or equal to −1.5 V, greater than or equal to −1.2 V, greater than or equal to −1 V, greater than or equal to −0.7 V, greater than or equal to −0.5 V, or greater than or equal to −0.2 V. Combinations of the above referenced ranges are also possible (e.g., less than or equal to −0.1 V and greater than or equal to −2.0V). Other ranges are also possible.

Those skilled in the art would understand that the magnitude of the negative electric potential may depend, at least in some part, on the electrode material (e.g., the reference electrode material, the working electrode material) and would be capable of selecting a suitable range of electric potentials based upon the teachings of this specification. For example, in some embodiments, the reference electrode comprises a carbon material and the negative electric potential may be selected to be less than or equal to −0.1 V and greater than or equal to −2.0V.

In certain embodiments, the electrolyte undergoes an intermediate redox reaction. Without wishing to be bound by theory, in some embodiments, the intermediate redox reaction oxidizes and/or promotes the deposition of the metal on the working electrode. In certain embodiments, however, the potential from the working electrode directly oxidizes the metal from the metal containing particle.

In certain embodiments, the deposited metal layer may be removed from the working electrode by changing a voltage on the working electrode. In some such embodiments, the current may be measured while changing the voltage to determine the amount of analyte present in the fluid. For example, as shown in FIG. 1A, current measuring step 185 comprises changing the voltage of the working electrode such that deposited metal 180 is removed from the working electrode, and quantifying the change in current on the working electrode. Without wishing to be bound by theory, an area under the curve of a plot of measuring current versus applied electric potential is a function of (e.g., proportional to) the amount of metal deposited on the working electrode, which is also a function of (e.g., proportional to) the amount of analyte originally present in the fluid. Accordingly, by measuring current by changing the voltage of the working electrode may determine the amount of analyte present in the fluid.

In some embodiments, the current is measured as the electric potential is changed (e.g., increased, decreased). In certain embodiments, the electric potential is changed at a particular rate. For example some embodiments, the electric potential is changed at a rate of at least 1 mV/s. In some embodiments, the electric potential is changed at a rate of at least 1 mV/s, at least 2 mV/s, at least 5 mV/s, at least 10 mV/s, at least 20 mV/s, at least 50 mV/s, at least 100 mV/s, at least 200 mV/s, at least 500 mV/s, at least 1 V/s, or at least 2 V/s. In certain embodiments, the electric potential is changed at a rate of less than or equal to 5 V/s, less than or equal to 2 V/s, less than or equal to 1 V/s, less than or equal to 500 mV/s, less than or equal to 200 mV/s, less than or equal to 100 mV/s, less than or equal to 50 mV/s, less than or equal to 20 mV/s, less than or equal to 10 mV/s, less than or equal to 5 mV/s, or less than or equal to 2 mV/s. Combinations of the above referenced ranges are also possible (e.g., at least 1 mV/s and less than or equal to 5 V/s, at least 10 mV/s and less than or equal to 100 mV/s, at least 50 mV/s and less than or equal to 500 mV/s, at least 100 mV/s and less than or equal to 1 V/s, at least 500 mV/s and less than or equal to 5 V/s). Other ranges are also possible.

As described above, the methods described herein may be useful for determining and/or quantifying the amount of analyte present in the fluid or sample. In some embodiments, the fluid is whole blood. In certain embodiments the fluid is a sample obtained from a patient such as whole blood, serum, plasma, urine, sputum, sweat, and/or other biological fluids. Methods for collecting such fluids are known in the art. In some embodiments, the fluid or sample is diluted prior to determining and/or quantifying the amount of analyte present in the fluid or sample. For example, in certain embodiments, the fluid or sample is diluted in a buffer solution prior to, or during, the step of introducing the plurality of capture structures and/or the plurality of metal-containing particles to the fluid or sample.

In some embodiments, an analyte in a fluid or sample is readily determinable without any subsequent process steps (e.g., a protein circulating free in blood or in a complex in blood, such as cardiac troponin). In other embodiments, however, the analyte (or the sample containing the analyte) is first processed to expose the analyte to allow it to be determinable by one or more methods described herein. For example, in some embodiments, the analyte is present in (e.g., contained within or on) an analyte-containing biological particle, which is present in the fluid or sample. For example, the analyte-containing biological particle may be a virion, a bacterium, a protein complex, an exosome, a cell, or fungi.

In some embodiments, the methods described herein comprise exposing the analyte from the biological particle such that the analyte is available to form a bound complex. For example, in some embodiments, the analyte-containing biological particle is lysed such that the analyte is released from the analyte-containing biological particle. In some such embodiments, a lysing solution may be added to the analyte such that the analyte is released from the analyte-containing biological particle. Lysing solutions are described in more detail below. In certain embodiments, the analyte-containing biological particle is lysed via mechanical agitation, heating, washing, and/or shearing of the analyte-containing biological particle (e.g., via ultrasonic agitation).

In an exemplary embodiment, the lysing step (e.g., comprising adding the lysing solution) may open up HCV virions to release the core antigen, monomerize the core antigen, inactivate the host-derived antibodies against the core antigen, and/or dissociate the core antigen from the interactions with blood components other than the antibody against the core antigen.

In some embodiments, exposing analyte from the biological particle such that the analyte is available to form a bound complex comprises changing the pH, temperature, and/or ionic strength of the fluid comprising biological particle such that the analyte is available to form a bound complex.

In some embodiments, prior to introducing the metal-containing particles and/or the capture substrates to the analyte, an analyte-containing biological particle may be isolated (e.g., isolated from the fluid sample). For example, in some embodiments, a sample comprising a plurality of analyte-containing biological particles is added to a capture substrate, or the capture substrate is exposed to a fluid including the plurality of analyte-containing biological particles. In certain embodiments, the capture substrate and a buffer solution are added to a sample comprising a plurality of analyte-containing biological particles. At least a portion of the analyte-containing biological particles may attach to the capture substrate. In certain embodiments, the analyte-containing biological particle may attach to the capture substrate via formation of a non-specific bond. In some cases, the analyte-containing biological particle may interact with a functional group present on the surface of the capture substrate. For example, the analyte-containing biological particle may attach to the capture substrate and/or a functional group present on the surface of the capture substrate via a bond such as an ionic bond, a covalent bond (e.g., carbon-carbon, carbon-oxygen, oxygen-silicon, sulfur-sulfur, phosphorus-nitrogen, carbon-nitrogen, metal-oxygen, or other covalent bonds), a hydrogen bond (e.g., between hydroxyl, amine, carboxyl, thiol, and/or similar functional groups), a dative bond (e.g., complexation or chelation between metal ions and monodentate or multidentate ligands), and/or Van der Waals interactions. In an exemplary embodiment, the capture substrate nonspecifically binds to the analyte-containing biological particle (e.g., a virion, a whole blood cell).

In certain embodiments, any components not attached to the capture substrate may be removed. In some cases, removing components not attached to the capture substrate involves a magnetic separation and/or a washing step (e.g., washing the capture substrate with a hypotonic solution). For example, in some embodiments, the capture substrate comprises a plurality of magnetic particles. In some such embodiments, a magnet and/or magnetic field may be applied to the capture substrate such that the capture substrate is isolated within the fluid sample, and the unbound components may be removed. Referring to FIG. 1C, exemplary method 200 comprises collecting, from a patient, biological sample 210 comprising an analyte-containing biological particle. In certain embodiments, capture substrate 215 comprising a magnetic material may be added to biological sample 210. In some embodiments, the analyte-containing biological particle attaches to capture substrate 215 forming mixture 230 comprising the analyte-containing biological particle attached to the capture substrate. Mixture 230 may be isolated from any unbound components 235 by exposing mixture 230 to magnet 220 and removing (e.g., via aspiration) the unbound components. In some embodiments, mixture 230 may be resuspended in a fluid forming analyte-containing fluid 240. In some cases, analyte-containing fluid 240 comprises an analyte-containing biological particle that may be exposed such that the analyte is available to form a bound complex, as described above. For instance, the analyte-containing biological particles may be resuspended in the electrolyte. After isolation and/or resuspension of the analyte-containing biological particle, the analyte may be exposed such that the analyte is available to form a bound complex, as described above.

The capture substrate may comprise any suitable material capable of facilitating attachment of an analyte-containing biological particle. For example, in some embodiments, capture substrate comprises a magnetic material. In some cases, the capture substrate may be charged. In certain embodiments, the capture substrate may be uncharged. Advantageously, in some embodiments the capture substrates described herein may permit the nonspecific capture of analyte-containing biological particles, e.g., without the need for functionalizing the surface of the capture substrate with specific antibodies corresponding to the analyte and/or specific functional groups.

In certain embodiments, the capture substrate comprises a plurality of beads. In some such embodiments, the plurality of beads may be magnetic. In certain embodiments, the plurality of these may be substantially non-magnetic (e.g., polystyrene beads). The plurality of beads may have any suitable size. For example, in some embodiments, the plurality of beads have an average diameter of at least 40 nm, at least 50 nm, at least 60 nm, at least 70 nm, at least 80 nm, at least 90 nm, at least 100 nm, at least 200 nm, at least 500 nm, at least 1 micron, or at least 2 microns. In certain embodiment, the plurality of beads have an average diameter of less than or equal to 5 microns, less than or equal to 2 microns, less than or equal to 1μ, less than or equal to 500 nm, less than or equal to 400 nm, less than or equal to 300 nm, or less than or equal to 200 nm. Combinations of the above referenced ranges are also possible (e.g., at least 100 nm and less than or equal to 5 microns). Other ranges are also possible.

Additional non-limiting examples of suitable capture substrates include woven pads, non-woven pads, non-magnetic resins, polymeric packing (e.g., polystyrene-divinylbenzene), and microfibers (e.g., electrospun microfibers).

As described above, in some embodiments, a buffer solution may be added to a sample and/or a fluid. In certain embodiments, the buffer solution comprises a salt. In certain embodiments, the buffer solution comprises a chlorine-containing salt. In some embodiments, the salt is selected from the group consisting of sodium acetate, zinc acetate, NaCl, LiCl, CsCl, copper acetate, and combinations thereof. In some cases, the buffer solution may comprise metal acetate. In some solutions, the buffer solution is selected for use with whole blood.

In some embodiments, the buffer solution comprises a salt and has a salt concentration of at least 1 mM, at least 2 mM, at least 5 mM, at least 10 mM, at least 20 mM, at least 50 mM, at least 100 mM, at least 200 mM, at least 500 mM, at least 1 M, or at least 2 M. In certain embodiments, the buffer solution has a salt concentration of less than or equal to 5 M, less than or equal to 2 M, less than or equal to 1 M, less than or equal to 500 mM, less than or equal to 200 mM, less than or equal to 100 mM, less than or equal to 50 mM, less than or equal to 20 mM, less than or equal to 10 mM, less than or equal to 5 mM, or less than or equal to 2 mM. Combinations of the above-referenced ranges are also possible (e.g., at least 1 mM and less than or equal to 1, at least 5 mM and less than or equal to 5 M). Other ranges are also possible. For example, in an exemplary embodiment, the buffer solution comprises 50 mM sodium acetate, at least 1 mM and less than or equal to 5 mM zinc acetate, and at least 50 mM and less than or equal to 200 mM sodium chloride.

In certain embodiments, the buffer solution has a pH of at least 4, at least 5, at least 6, at least 7, at least 8, or at least 9. In some embodiments, the buffer solution has a pH of less than or equal to 9, less than or equal to 8, less than or equal to 7, less than or equal to 6, or less than or equal to 5. Combinations of the above reference ranges are also possible (e.g., at least 4 and less than or equal to 10, at least 4 and less than or equal to 7). Other ranges are also possible.

As described above, in certain embodiments, a lysing solution may be added to a sample comprising a plurality of analyte-containing biological particles (e.g., cells) to expose the analyte from the analyte-containing biological particle such that the analyte is available to form a bound complex. In certain embodiments, the lysing solution comprises a detergent, a denaturant, a reducing agent, an acid (e.g., a strong acid) or combinations thereof.

In some embodiments, the detergent includes a surfactant. In certain embodiments, the surfactant is an anionic surfactant (e.g., sodium dodecyl sulfate (SDS)), a cationic surfactant (e.g., alkyltrimethyl ammonium chloride, alkylmethyl ammonium bromide), a non-ionic surfactant (e.g., an alkyl poly(ethylene oxide) such as Triton X-100), or a zwitterionic surfactant (e.g., 3-[(3-cholamidopropyl)dimethylammonio]-1-propanesulfonate, lauryl sulfobetaine, N-hexadecyl-N,N-dimethyl-3-ammonio-1-propanesulfonate).

In some embodiments, the lysing solution comprises a denaturant such as quanidium hydrochloride, sodium thiocyanate, or urea.

In certain embodiments, the lysing solution comprises a reducing agent. Non-limiting examples of reducing agents include mercaptoethanol, DTT, glutathione, cysteine, tris(2-carboxyethyl)phosphine hydrochloride, cysteamine, dimethylamino ethanethiol, diethylaminoethanethiol, and diisopropylaminoethanethiol.

In some embodiments, a blocking agent may be added to the fluid comprising the analyte. The blocking agent may reduce any undesirable non-specific binding/adsorption. Non-limiting examples of suitable blocking agents include bovine serum albumin (BSA), casein, fish gelatin, polyvinylpyrrolidone, pig gelatin, mouse serum, or the like. Those skilled in the art would be capable of selecting suitable blocking agents for use with a particular binding event between pairs of biological molecules based upon the teachings of the specification.

As described herein, in some embodiments, methods used to quantify the amount of analyte present in a fluid sample from a patient is provided. In some embodiments, the methods described herein may be useful for detecting the presence of one or more antigens (e.g., a viral antigen such as cAg or p24, or a protein circulating free in blood or in a complex in blood, such as cardiac troponin) in a fluid sample from a patient.

In an exemplary embodiment, a sample suspected of containing the hepatitis C virus may be added to a capture substrate such that at least a portion of the viruses attach to the capture substrate. Any components from the sample not attached to the substrate may then be removed. The virus may then be lysed such that an analyte such as cAg or other HCV antigen is exposed and capable of forming a bound complex with a capture structure and a metal-containing particle. A plurality of capture structures and a plurality of metal-containing particles may then be added to the analyte to form the bound complex. Any unbound metal-containing particles may be separated from the bound complex and an electrolyte may be added to the bound complex. Voltammetry may be then performed to determine the amount of analyte present. In some cases, the analyte may be present in the sample in a manner suitable for forming a bound complex, and the method does not require using a capture substrate to isolate the analyte or lysing of an analyte-containing biological particle.

In another exemplary embodiment, an analyte is released from an analyte-containing bioparticle in a sample. For example, a sample including analyte-containing bioparticles suspected of containing the hepatitis C virus may be lysed such that an analyte, e.g., cAg or other HCV antigen, is exposed and capable of forming a bound complex with a capture structure and a metal-containing particle. In some embodiments, no capture substrates are added to the sample prior to the lysing step. After the lysing step, a plurality of capture structures and a plurality of metal-containing particles may then be added to the analyte to form the bound complex. Any unbound metal-containing particles may be separated from the bound complex and an electrolyte may be added to the bound complex. Voltammetry may be then performed to determine the amount of analyte present, as described herein. In some cases, the analyte may be present in the sample in a manner suitable for forming a bound complex, and the method does not require using a capture substrate to isolate the analyte and/or lysing of an analyte-containing biological particle.

In some embodiments, plasma separation of the sample is conducted prior to adding the sample to the capture substrates. Those skilled in the art would be capable of selecting suitable methods, such as centrifugation of filtration (e.g., a membrane based separator), for separating plasma from a sample (e.g., a whole blood sample).

In alternative embodiments, no plasma separation step is conducted (e.g., a whole blood sample is introduced into the device). For example, in some embodiments, a sample such as blood suspected of containing the HIV virion may be added directly to a capture substrate without plasma separation.

For example, in an exemplary embodiment, a sample suspected of containing the HIV virus may be added to a capture substrate such that at least a portion of the viruses attach to the capture substrate. Any components from the sample not attached to the substrate may then be removed. The virus may then be lysed such that an analyte, e.g., p24 or other HIV antigen, is exposed and capable of forming a bound complex with a capture structure and a metal-containing particle. A plurality of capture structures and a plurality of metal-containing particles may then be added to the analyte to form the bound complex. Any unbound metal-containing particles may be separated from the bound complex and an electrolyte may be added to the bound complex. Voltammetry may be then performed to determine the amount of analyte present, as described herein. In some cases, the analyte may be present in the sample in a manner suitable for forming a bound complex, and the method does not require using a capture substrate to isolate the analyte or lysing of an analyte-containing biological particle.

In yet another exemplary embodiment, a sample suspected of containing a protein, such as freely circulating proteins in the sample (e.g., a cardiac marker protein such as Troponin I), may be added to a plurality of capture structures and a plurality of metal-containing particles such that the analyte, capture structures, and metal-containing particles form a bound complex. Any unbound metal-containing particles may be separated from the bound complex and an electrolyte may be added to the bound complex, as described herein. Voltammetry may be then performed to determine the amount of analyte present. In some cases, the analyte may be present in the sample in a manner suitable for forming a bound complex, and the method does not require using a capture substrate to isolate the analyte or lysing of an analyte-containing biological particle.

In certain embodiments, the presence of a particular antigen may indicate the patient carries a particular disease. For example, a patient may be diagnosed with a particular disease or condition (e.g., hepatitis C) if the methods described herein determine that cAg (or another HCV antigen) is present in the fluid sample from the patient. Accordingly, a method described herein may involve diagnosing a patient having (or suspected of having) hepatitis Cby testing a sample (e.g., a whole blood sample) from the subject containing an HCV antigen and/or cAg using one or more methods described herein. The method may involve diagnosing the patient as not having hepatitis C, in embodiments in which the sample from the subject does not contain an HCV antigen and/or cAg. In some embodiments, a method involves identifying a patient, from two or more patients, as having or not having hepatitis C, by testing patient samples (e.g., whole blood samples) from the two or more patients according to one or more of the methods described herein. The method may involve determining the patient as having hepatitis C where the patient sample contains an HCV antigen and/or cAg, or determining that the patient does not have hepatitis C where the patient sample does not contain the HCV antigen and/or cAg.

In another example, a patient may be diagnosed with a particular disease or condition (e.g., HIV/AIDS) if the methods described herein determine that p24 (or another HIV antigen) is present in the fluid sample from the patient. Accordingly, a method described herein may involve diagnosing a patient having (or suspected of having) HIV infection by testing a sample (e.g., a whole blood sample) from the subject containing an HIV antigen using one or more methods described herein. The method may involve diagnosing the patient as not having HIV infection, in embodiments in which the sample from the subject does not contain an HIV antigen. In some embodiments, a method involves identifying a patient, from two or more patients, as having or not having HIV infection, by testing patient samples (e.g., whole blood samples) from the two or more patients according to one or more of the methods described herein. The method may involve determining the patient as having HIV infection where the patient sample contains an HIV antigen, or determining that the patient does not have HIV infection where the patient sample does not contain the HIV antigen.

In yet another example, a patient may be diagnosed with a particular disease or condition (e.g., heart disease and/or risk for myocardial infarction) if the methods described herein determine that Troponin I (or another suitable cardiac marker protein) is present in the fluid sample from the patient. Accordingly, a method described herein may involve diagnosing a patient having (or suspected of having) heart disease by testing a sample (e.g., a whole blood sample) from the subject containing a cardiac marker protein such as Troponin I using one or more methods described herein. The method may involve diagnosing the patient as not having heart disease, in embodiments in which the sample from the subject does not contain, or contains a relatively low concentration of, a cardiac marker protein such as Troponin I. In some embodiments, a method involves identifying a patient, from two or more patients, as having or not having heart disease, by testing patient samples (e.g., whole blood samples) from the two or more patients according to one or more of the methods described herein. The method may involve determining the patient as having heart disease where the patient sample contains the cardiac marker protein (or a relatively high concentration of the cardiac marker protein), or determining that the patient does not have heart disease where the patient sample does not contain the cardiac marker protein (or a relatively low concentration of the cardiac marker protein).

In some embodiments, the methods described herein can be performed in a microfluidic device. For example, in certain embodiments, the capture substrate, metal-containing particles, and/or the analyte may be added to a channel of a microfluidic device such that the bound complex is formed within the channel. In some embodiments, introducing or exposing a plurality of capture structures and a plurality of metal-containing particles to a fluid comprising the analyte such that the analyte binds with both a capture structure and a metal-containing particle to form a bound complex may occur within a microfluidic device (e.g., within a channel of a microfluidic device). In certain embodiments, the bound complex may be exposed to an electrolyte within a microfluidic device (e.g., within a channel of a microfluidic device). In some cases, an electric potential may be applied to at least a portion of a microfluidic device such that at least a portion of the metal from the metal-containing particles is oxidized, or such that at least a portion of the metal is deposited onto an electrode material within the microfluidic device (e.g., within a channel of a microfluidic device). In some embodiments, measuring current by changing a voltage to determine the amount of analyte present in the fluid occurs within the microfluidic device (e.g., within a channel of a microfluidic device). In some cases, the capture substrate may be present within, and/or a component of. the microfluidic device (e.g., a plurality of posts within a channel of the microfluidic device).

In certain embodiments, a channel of a device that can be used to perform a method described herein has a particular average cross-sectional dimension. The “cross-sectional dimension” (e.g., a diameter) of the channel is measured perpendicular to the direction of fluid flow. In some embodiments, the average cross-sectional dimension of the channel is less than or equal to about 2 mm, less than or equal to about 1 mm, less than or equal to about 800 microns, less than or equal to about 600 microns, less than or equal to about 500 microns, less than or equal to about 400 microns, or less than or equal to about 300 microns. In certain embodiments, the average cross-sectional dimension of the channel is greater than or equal to about 250 microns, greater than or equal to about 300 microns, greater than or equal to about 400 microns, greater than or equal to about 500 microns, greater than or equal to about 600 microns, greater than or equal to about 800 microns, or greater than or equal to about 1 mm. Combinations of the above-referenced ranges are also possible (e.g., between about 250 microns and about 2 mm, between about 400 microns and about 1 mm, between about 300 microns and about 600 microns). Other ranges are also possible. In some cases, more than one channel or capillary may be used.

The channel of the device that can be used to perform a method described herein can have any suitable cross-sectional shape (circular, oval, triangular, irregular, trapezoidal, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and outlet(s). A channel may also have an aspect ratio (length to average cross sectional dimension) of at least 2:1, more typically at least 3:1, 5:1, or 10:1 or more. An open channel generally will include characteristics that facilitate control over fluid transport, e.g., structural characteristics (an elongated indentation) and/or physical or chemical characteristics (hydrophobicity vs. hydrophilicity) or other characteristics that can exert a force (e.g., a containing force) on a fluid. The fluid within the channel may partially or completely fill the channel. In some cases where an open channel is used, the fluid may be held within the channel, for example, using surface tension (e.g., a concave or convex meniscus).

The channel or device that can be used to perform a method described herein can have any suitable volume. In some embodiments, the volume of the channel may be at least 0.1 microliters, at least 0.5 microliters, at least 1 microliter, at least 2 microliters, at least 5 microliters, at least 7 microliters, at least 10 microliters, at least 12 microliters, at least 15 microliters, at least 20 microliters, at least 30 microliters, or at least 50 microliters. In certain embodiments, the volume of the channel may be less than or equal to 100 microliters, less than or equal to 70 microliters, less than or equal to 50 microliters, less than or equal to 25 microliters, less than or equal to 10 microliters, or less than or equal to 5 microliters. Combinations of the above-referenced ranges are also possible (e.g., between 1 microliter and 10 microliters). Other ranges are also possible.

Fluids (e.g., comprising the plurality of capture structures, the plurality of metal-containing particles, the capture substrates, the electrolyte, the lysing solution, the buffer solution, and/or the analyte) can be pushed into the channel or device using any suitable component, for example, a pump, syringe, pressurized vessel, or any other source of pressure. Alternatively, fluids can be pulled into the channel or device by application of vacuum or reduced pressure on a downstream side of the channel or device. Vacuum may be provided by any source capable of providing a lower pressure condition than exists upstream of the channel or device. Such sources may include vacuum pumps, venturis, syringes and evacuated containers. It should be understood, however, that in certain embodiments, methods described herein can be performed with a changing pressure drop across an inlet and an outlet of the microfluidic device by using capillary flow, the use of valves, or other external controls that vary pressure and/or flow rate.

A microfluidic device or portions thereof (e.g., a component, a surface, a channel) used to perform a method described herein can be fabricated of any suitable material. Non-limiting examples of materials include polymers (e.g., polypropylene, polyethylene, polystyrene, poly(acrylonitrile, butadiene, styrene), poly(styrene-co-acrylate), poly(methyl methacrylate), polycarbonate, poly(dimethylsiloxane), PVC, PTFE, PET, or blends of two or more such polymers, or metals including nickel, copper, stainless steel, bulk metallic glass, or other metals or alloys, or ceramics including glass, quartz, silica, alumina, zirconia, tungsten carbide, silicon carbide, or non-metallic materials such as graphite, silicon, or others.

In some embodiments, an electrode may be included in a channel (e.g., microfluidic channel) of a device that can be used to perform a method described herein. In some embodiments, an electrode may be formed by methods described in U.S. Publication No. 2012/279298, filed May 4, 2012, and entitled “Conductive patterns and methods for making conductive patterns”, which is incorporated herein by reference in its entirety for all purposes. Other electrodes are also possible. In some cases, an electrode (e.g., included in a channel of a microfluidic device that can be used to perform a method described herein) can be electrically connected to a power source. The power source can selectively apply a potential to the electrode to change a solid-fluid contact angle between the electrode and the fluid in a channel of a microfluidic device. This phenomenon, known as “electrowetting,” can be used to actively change the fluid flow dynamics in a micro-channel. For example, a series of conductive transfer material deposits can selectively receive a pulse from a power source to create a pulsed flow of fluid.

In some embodiments, the methods described herein can be carried out or used in combination with the methods, components, systems, and/or devices (e.g., microfluidic devices) described in one or more of: U.S. Pat. No. 8,852,875, issued Oct. 7, 2014, and entitled “Methods for Counting Cells”; U.S. Pat. No. 8,911,957, issued Dec. 16, 2014, and entitled “Devices and methods for detecting cells and other analytes”; U.S. Publication No. 2015/190802, filed Jan. 6, 2015, and entitled “Fluid delivery devices, systems, and methods”; U.S. Publication No. 2015/190805, filed Jan. 7, 2015, and entitled “Fluid delivery devices, systems, and methods”; U.S. Publication No. 2015/056717, filed Aug. 20, 2014, and entitled “Microfluidic metering of fluids”; U.S. Publication No. 2013/295588, filed Nov. 9, 2011, and entitled “Counting particles using an electrical differential counter”; and International Patent Application No. WO 2012/064704, filed Nov. 8, 2011 and entitled “Multi-function microfluidic test kit”, each of which is incorporated herein by reference in its entirety for all purposes. A “subject” or a “patient” refers to any animal such as a mammal (e.g., a human), for example, a mammal that may be susceptible to a disease or bodily condition. Examples of subjects or patients include a human, a non-human primate, a cow, a horse, a pig, a sheep, a goat, a dog, a cat or a rodent such as a mouse, a rat, a hamster, a bird, a fish, or a guinea pig. Generally, the invention is directed toward use with humans. A patient may be a subject diagnosed with a certain disease or bodily condition or otherwise known to have a disease or bodily condition. In some embodiments, a patient may be diagnosed as, or known to be, at risk of developing a disease or bodily condition. In other embodiments, a patient may be suspected of having or developing a disease or bodily condition, e.g., based on various clinical factors and/or other data.

As used herein, the term “small molecule” refers to molecules, whether naturally occurring or artificially created (e.g., via chemical synthesis) that have a relatively low molecular weight. Typically, a small molecule is an organic compound (i.e., it contains carbon). The small molecule may contain multiple carbon-carbon bonds, stereocenters, and other functional groups (e.g., amines, hydroxyl, carbonyls, and heterocyclic rings, etc.). In certain embodiments, the molecular weight of a small molecule is at most about 1,000 g/mol, at most about 900 g/mol, at most about 800 g/mol, at most about 700 g/mol, at most about 600 g/mol, at most about 500 g/mol, at most about 400 g/mol, at most about 300 g/mol, at most about 200 g/mol, or at most about 100 g/mol. In certain embodiments, the molecular weight of a small molecule is at least about 100 g/mol, at least about 200 g/mol, at least about 300 g/mol, at least about 400 g/mol, at least about 500 g/mol, at least about 600 g/mol, at least about 700 g/mol, at least about 800 g/mol, or at least about 900 g/mol, or at least about 1,000 g/mol. Combinations of the above ranges (e.g., at least about 200 g/mol and at most about 500 g/mol) are also possible.

As used herein, the term “drug” refers to an agent that is administered to a subject to treat a disease, disorder, or other clinically recognized condition, or for prophylactic purposes, and has a clinically significant effect on the body of the subject to treat and/or prevent the disease, disorder, or condition. Drugs include, without limitation, agents listed in the United States Pharmacopeia (USP), Goodman and Gilman's The Pharmacological Basis of Therapeutics, 10th Ed., McGraw Hill, 2001; Katzung, B. (ed.) Basic and Clinical Pharmacology, McGraw-Hill/Appleton & Lange, 8^{th} edition (Sep. 21, 2000); Physician's Desk Reference (Thomson Publishing); and/or The Merck Manual of Diagnosis and Therapy, 17th ed. (1999), or the 18th ed (2006) following its publication, Mark H. Beers and Robert Berkow (eds.), Merck Publishing Group, or, in the case of animals, The Merck Veterinary Manual, 9th ed., Kahn, C. A. (ed.), Merck Publishing Group, 2005. Preferably, though not necessarily, the drug is one that has already been deemed safe and effective for use in humans or animals by the appropriate governmental agency or regulatory body. For example, drugs approved for human use are listed by the FDA under 21 C.F.R. §§330.5, 331 through 361, and 440 through 460, incorporated herein by reference; drugs for veterinary use are listed by the FDA 4232215.1-37-under 21 C.F.R. §§500 through 589, incorporated herein by reference. All listed drugs are considered acceptable for use in accordance with the present invention.

### EXAMPLES

The following examples are intended to illustrate certain embodiments described herein, including certain aspects of the present invention, but do not exemplify the full scope of the invention.

### Example 1

The following example demonstrates a general method for determining and/or quantifying an analyte from a whole blood sample, according to the methods described herein.

HCV virions were captured from plasma and blood samples after dilution of the whole blood samples 2-5 fold in a buffer containing sodium acetate, zinc acetate, and sodium chloride, and incubating with capture substrates (capture structures) while mixing for 5 minutes. Capture structures were then separated by placing the tubes into a magnetic separator and removing the unbound supernatant. The amount of captured virions in this process typically exceeded 90% (measured by RT-PCR) and is shown in FIGS. 1D-1E. After a brief wash step, particles were separated again and are ready for the next step—lysis.

In one experiment, 60 μl of blood was mixed with 0.5 mg of capture structures and 240 μl of capture buffer containing 62.5 mM sodium acetate, pH 5.6, 2.5 mM zinc acetate and 104 mM NaCl to achieve a final concentration of 50 mM sodium acetate, 2 mM zinc acetate and 83 mM sodium chloride. At least 2 mM zinc acetate was used for K3EDTA-treated blood, 4 mM for citrate-treated blood, and 1 mM for heparin-treated blood.

Virions attached to the capture substrates (capture structures) were lysed in a lysis solution containing detergents, and/or denaturants and/or reducing agents to release the core antigen, which was subsequently detected. The lysis step opened up HCV particles to release the core antigen, monomerized the core antigen, inactivated the host-derived antibodies against the core antigen, and dissociated the core antigen from the interactions with blood components other than the antibody against the core antigen.

Lysing can be performed, for example, by combining 100 μl sample with 50 μl treatment solution, of the following composition:

15% SDS

2% CHAPS

0.3% Triton X-100

Optionally, 2 M urea

Incubated at 56° C. for 30 minutes. In an ELISA well, 100 μl treated sample can be mixed, for example, with 100 μl of reaction buffer, of the following composition:

1% BSA

5 mM EDTA

0.1 M NaCl

3% mouse serum

0.3% Triton X-100

0.1M phosphate buffer pH 7.2

ELISA was performed as a control. Optionally, lysis can also be performed, for example, by combining sample and treatment solution containing detergent and acid such as 0.25M HCl and 7% Triton X-100, 3.5% dodecylethylmethacrylatedimethylammonium bromide (C12PS) and 7% dodecyltrimethylammonium chloride (C12TAC) and incubating for 5 minutes. The treated sample may then be neutralized by adding a neutralization solution containing, for example, 0.25M Tris, pH 7.6.

The lysed components (“lysate”) in the lysis may contain detergents at a concentration in which detection may not be accurately performed. Therefore, the first step of the detection module was to dilute the lysate so that the matrix was compatible with the detection assay. The dilution factor is generally a function of the volume of the lysate, the concentration of the detergents, and/or the robustness of downstream components to the chosen detergents.

3 μg of 200 nm HCV specific silver particles are added to the diluted lysate. Particles were incubated with the lysate at room temperature for 15 minutes. Prior to running the assay, the silver particles were coated with antibodies able to capture the analyte. For example, protocols for conjugating antibodies included EDC coupling of antibodies to carboxylic acids on lipoic acid molecules that have already been attached to the silver particles.

The size of the silver particle was chosen as a balance between amplification (larger silver particles generally lead to larger amplification during electrochemical quantification) and labeling efficiency (smaller silver particles generally lead to improved ability to label every antigen with a silver particle and a capture structure.)

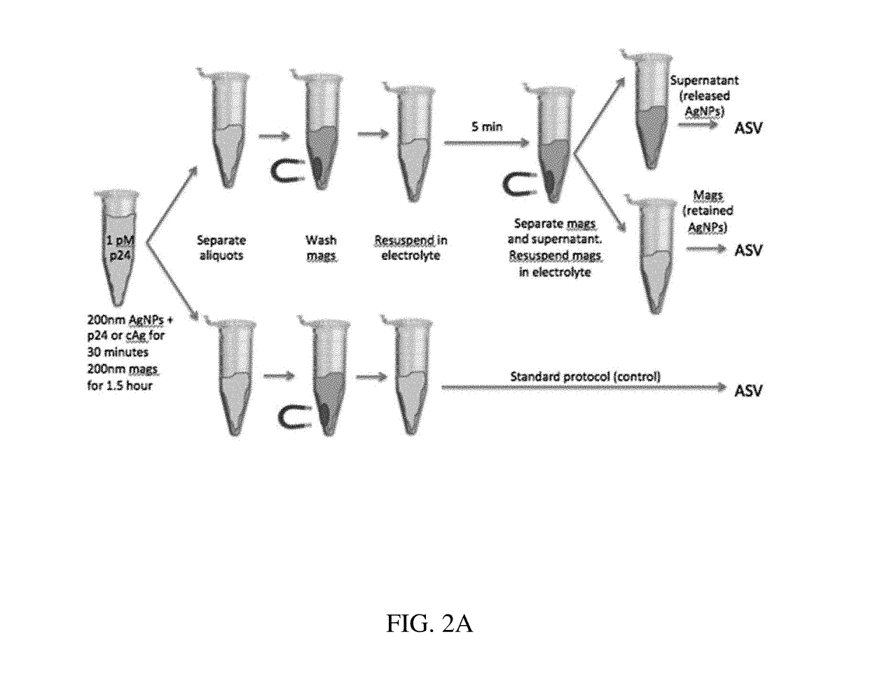

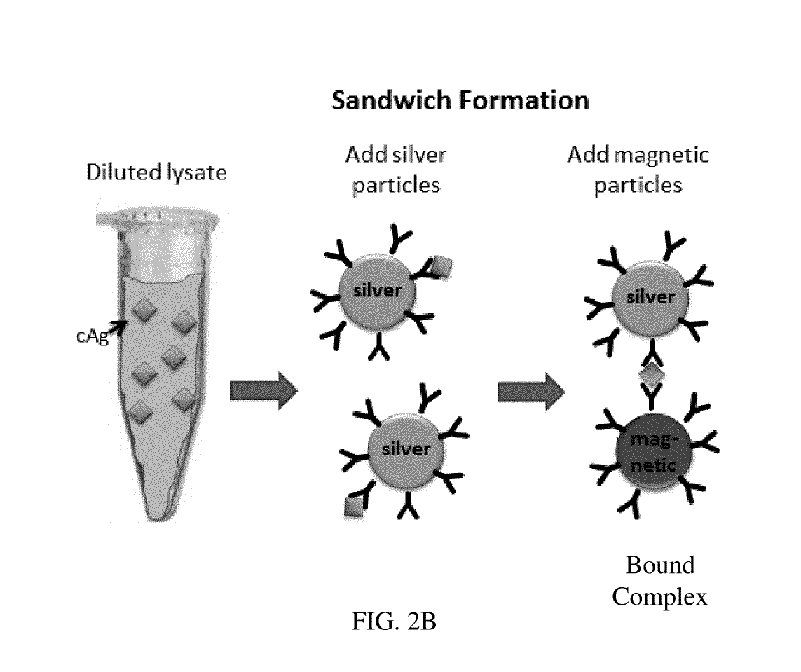

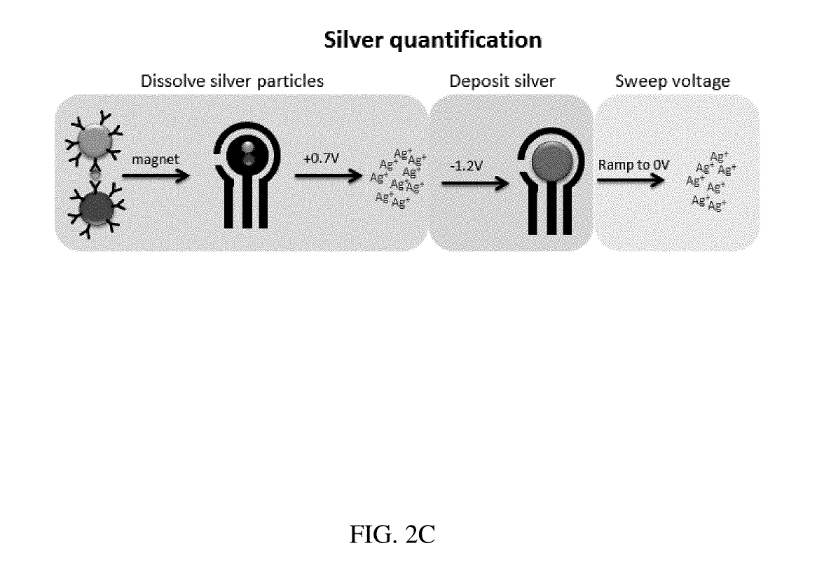

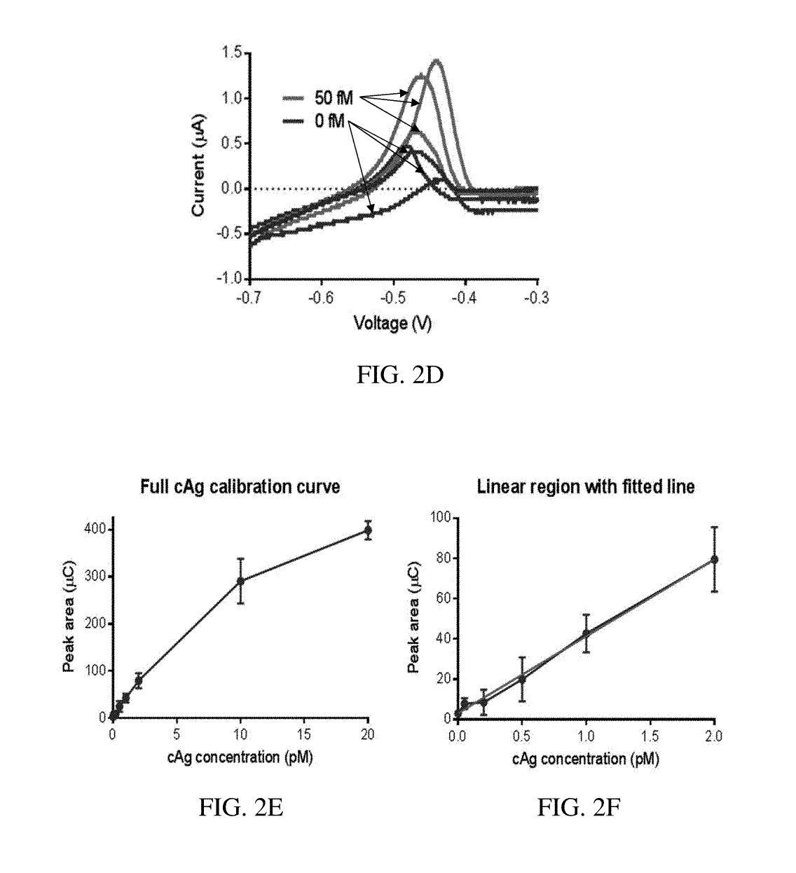

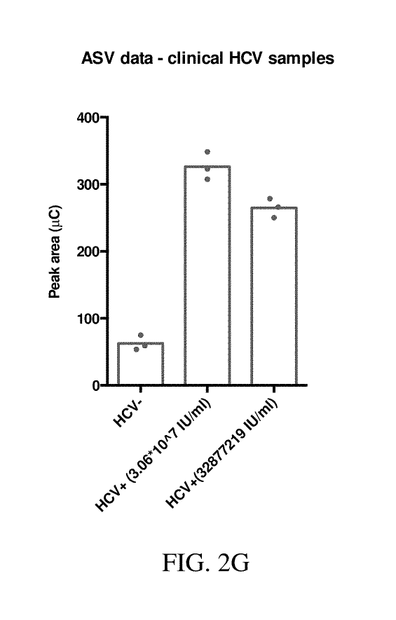

50 μg of 200 nm HCV specific magnetic beads were added to the solution above and incubated at room temperature for 60 minutes. Prior to running the assay, the capture structures were coated with antibodies able to capture the analyte. For example, protocols for coating the particles with antibodies included EDC coupling to carboxylic acids present on the surface of the particles. The size of the capture structure was chosen as a balance between steric hindrance (small particles are generally more likely to successfully bind to an analyte on a large silver particle) and magnetic moment (large particles generally have a higher magnetic moment and are more easily removed from solution with a magnet). An exemplary schematic of the above procedure is shown in FIG. 2A.

The solution of analyte (cAg), silver particles, and capture structures were placed on a magnetic stage. All capture structures, including those with analyte and silver attached are gathered near the magnet. Complexes containing a capture structure, an analyte molecule, and a silver particle are referred to as bound complex. The supernatant, including all unbound silver particles, was removed. Wash buffer was then added and the capture structures, including all bound complexes, were resuspended by vortexing and pipetting up and down. The resuspended bound complexes (mag) were then put back on the stage and the wash buffer was removed. A schematic of the bound complexes is shown in FIG. 2B.

The wash buffer was composed of, for example, 0.1% Casein and 0.05% tween-20 in PBS.

The capture structures and bound complexes were then resuspended in the electrolyte for the final electrochemical quantification of silver content. The electrolyte was, for example, 0.1 M NH4SCN. Other electrolytes such as NaCl, KCl, NaBr, and KI were also explored.

The remaining steps involve anodic stripping voltammetry (ASV) detection strategy and are schematized in FIG. 2C. The solution containing electrolyte, capture structures, and bound complexes was then transferred to a screen-printed electrode where the working, counter, and reference electrodes all included carbon ink. Under the working electrode was a magnet. After all capture structures migrated to the surface of the electrode, a positive potential was applied (30 seconds, +0.7V vs. carbon quasi-reference electrode). At this point the silver was oxidized from Ag(0) to Ag(I).

Silver was then deposited onto the electrode, beginning the Anodic Stripping Voltammetry (ASV) portion of the assay. Here, Ag(I) was deposited onto the working electrode with a negative potential (120 seconds, −1.2 V vs. carbon quasireference electrode.)

Silver was then stripped from the electrode, the second step for ASV. The potential of the working electrode was ramped from reducing (−1.0 V) to oxidizing (0 V) at 10 mV/s. When the voltage was at the potential for oxidizing silver, the current peaked (e.g., as shown in FIG. 2D). The area under the peak is directly related to the number of silver atoms oxidized. This number is then also proportional to the number of silver particles the analyte was able to successfully form bound complexes with. FIGS. 2E-2F show the concentration of the HCV core antigen versus peak current area (μC), comparing the analyte signal (50 fM) and the background signal (0 fM). Exemplary data obtained from HCV clinical samples is shown in FIG. 2G.

### Example 2

This example demonstrates the methods described herein compared to ELISA, as well as the limits of detection.

As shown in FIG. 3, HRP ELISA was performed in a 96 well plate with 100 μL p24 per well using the same antibodies as above. ELISA was detected via HRP quenched with TMB. The experiment was also performed with 50 μL of p24 per reaction according to Example 1 with 200 nm silver particles. Average of two duplicates was plotted for each technique.

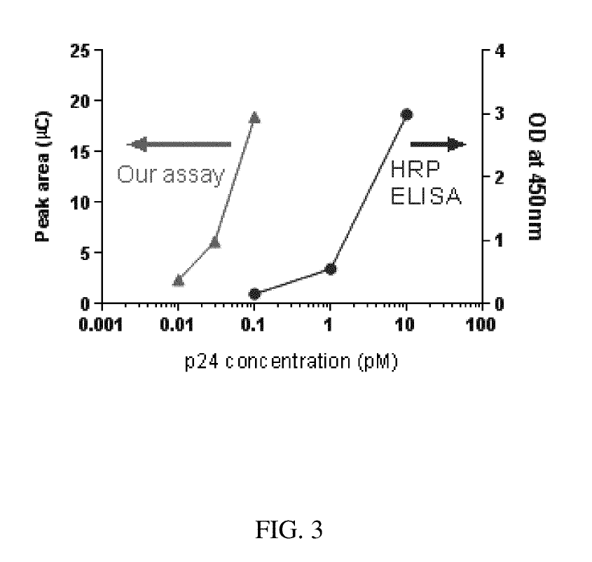

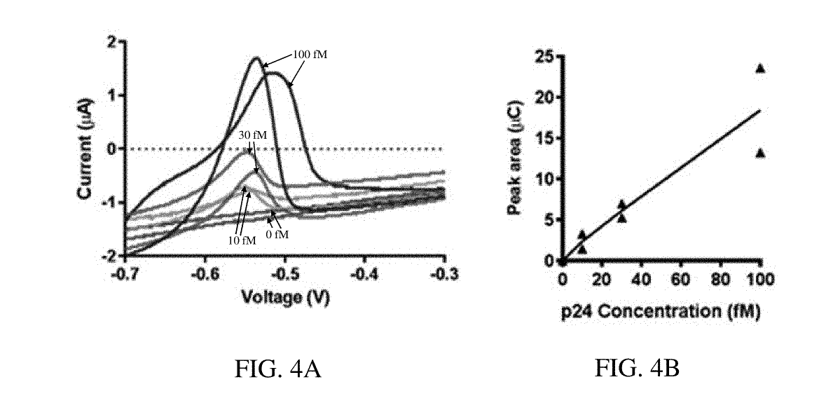

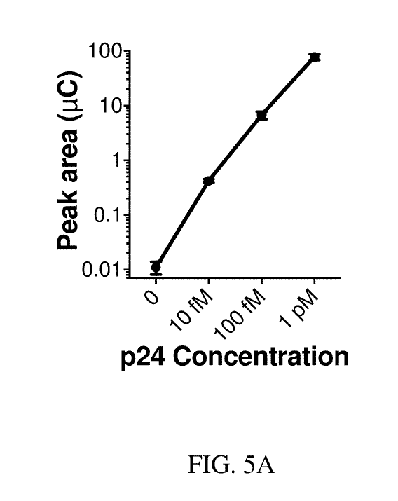

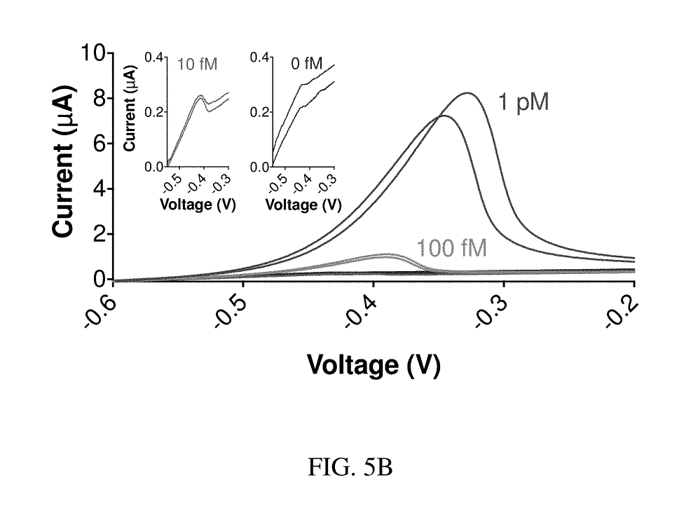

FIGS. 4A-5B show the limit of detection for various concentrations of p24 HIV antigen.

### Example 3

The following example demonstrates the effect of particle size on detection of p24 HIV antigen.

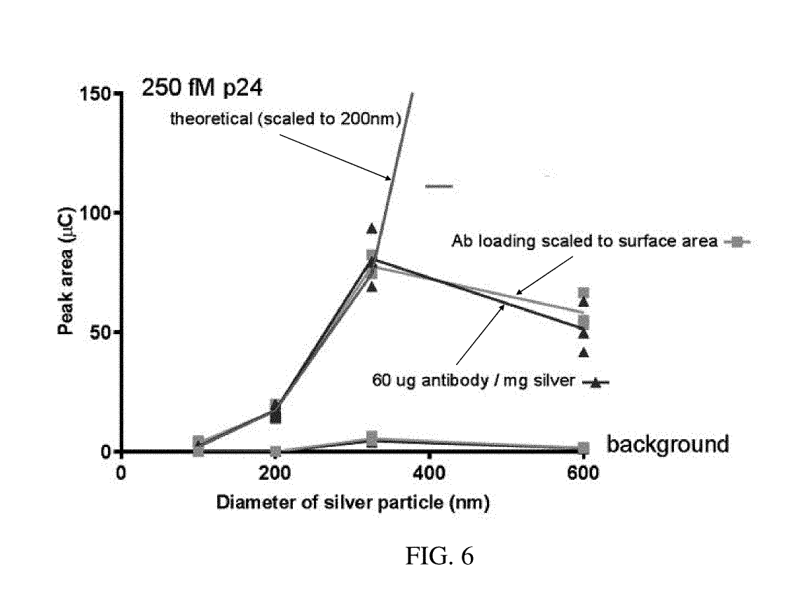

EDC coupling was used to conjugate antibody to a range of lipoic-acid coated silver particles from 100 nm to 600 nm. Antibody loading was either kept constant at 60 μg/mg silver or adjusted according to surface area. For each assay, 3 μg of silver was combined with 50 μL of a 250 fM p24 solution in PBS, 0.1% casein, 0.05% tween-20. As shown in FIG. 6, signal increases with particle volume when silver particles are 100 nm, 200 nm or 325 nm. For a particle diameter of 600 nm the signal was significantly lower than the theoretical curve. However, the concentration of silver particles in the immunoassay for 100 nm, 200 nm, 325 nm, and 600 nm were approximately 18 pM, 2.3 pM, 540 fM, 85 fM respectively.

### Example 4

The following example demonstrates the detection of HIV using the methods described herein.

HIV+ plasma samples were purchased from SeraCare®. All samples except the healthy plasma were positive for HIV RNA but negative for HIV antibodies.

HIV virions were captured from plasma and blood samples after dilution of the whole blood samples 2-5 fold in a buffer containing sodium acetate, zinc acetate, and sodium chloride, and incubating with capture substrates (capture structures) while mixing for 5 minutes. Capture structures were then separated by placing the tubes into a magnetic separator and removing the unbound supernatant. After a brief wash step, particles were separated again and are ready for the next step—lysis.

In one experiment, 60 μl of blood was mixed with 0.5 mg of capture structures and 240 μl of capture buffer containing 62.5 mM sodium acetate, pH 5.6, 2.5 mM zinc acetate and 104 mM NaCl to achieve a final concentration of 50 mM sodium acetate, 2 mM zinc acetate and 83 mM sodium chloride. At least 2 mM zinc acetate was used for K3EDTA-treated blood, 4 mM for citrate-treated blood, and 1 mM for heparin-treated blood.

Capture structures with attached virion particles were separated from blood solution by placing sample on magnet stage. All capture structures, including those with virions, are gathered near the magnet. Wash buffer was then added and the capture structures were resuspended by vortexing and pipetting up and down. The resuspended capture structures were then put back on the stage and the wash buffer was removed. The wash buffer was composed of, for example, 50 mM sodium acetate, pH 5.6.

Virions attached to the capture substrates (capture structures) were lysed in a lysis solution containing detergents, and/or denaturants and/or acidifying agents and/or reducing agents to release the p24, which was subsequently detected. The lysis step opened up HIV particles to release the p24, monomerized p24, inactivated the host-derived antibodies against the p24, and dissociated the core antigen from the interactions with blood components other than the antibody against p24.

Lysing can be performed, for example, by adding 6 ul treatment solution, containing 5% Triton X-100 (or 1% triton X-100 in PBS with 0.1% casein and 0.05% tween-20) to the capture structures containing attached virions and incubating at room temperature for 30 minutes. Capture structures were then removed from solution containing the lysed analyte by placing sample on magnet stage. Supernatant containing the virion-derived analytes was removed and placed to another tube. To inactivate the host-derived antibodies, 25 μl of glycine-HCl pH 1.8 was added to the 6 μl of solution containing lysed virions and sample was incubated at room temperature for 30 minutes. To neutralize the acid, 34 μl of neutralization buffer containing 25 μl of 1.5 M Tris, pH 11, 1% casein, 3 μl 1% Tween-20.

3 μg of 200 nm HIV specific silver particles are added to the neutralized lysate. Particles were incubated with the lysate at room temperature for 15 minutes. Prior to running the assay, the silver particles were coated with antibodies able to capture the analyte. For example, protocols for conjugating antibodies included EDC coupling of antibodies to carboxylic acids on lipoic acid molecules that have already been attached to the silver particles.

The size of the silver particle was chosen as a balance between amplification (larger silver particles generally lead to larger amplification during electrochemical quantification) and labeling efficiency (smaller silver particles generally lead to improved ability to label every antigen with a silver particle and a capture structure.)

50 μg of 200 nm HIV specific magnetic beads were added to the solution above and incubated at room temperature for 60 minutes. Prior to running the assay, the capture structures were coated with antibodies able to capture the analyte. For example, protocols for coating the particles with antibodies included EDC coupling to carboxylic acids present on the surface of the particles. The size of the capture structure was chosen as a balance between steric hindrance (small particles are generally more likely to successfully bind to an analyte on a large silver particle) and magnetic moment (large particles generally have a higher magnetic moment and are more easily removed from solution with a magnet). An exemplary schematic of the above procedure is shown in FIG. 2A.

The solution of analyte (p24), silver particles, and capture structures were placed on a magnetic stage. All capture structures, including those with analyte and silver attached are gathered near the magnet. Complexes containing a capture structure, an analyte molecule, and a silver particle are referred to as bound complex. The supernatant, including all unbound silver particles, was removed. Wash buffer was then added and the capture structures, including all bound complexes, were resuspended by vortexing and pipetting up and down. The resuspended bound complexes (mag) were then put back on the stage and the wash buffer was removed. A schematic of the bound complexes is shown in FIG. 2B.

The wash buffer was composed of, for example, 0.1% Casein and 0.05% tween-20 in PBS.

The capture structures and bound complexes were then resuspended in the electrolyte for the final electrochemical quantification of silver content. The electrolyte was, for example, 0.1 M NH4SCN. Other electrolytes such as NaCl, KCl, NaBr, and KI were also explored.

The remaining steps involve anodic stripping voltammetry (ASV) detection strategy and are schematized in FIG. 2C. The solution containing electrolyte, capture structures, and bound complexes was then transferred to a screen-printed electrode where the working, counter, and reference electrodes all included carbon ink. Under the working electrode was a magnet. After all capture structures migrated to the surface of the electrode, a positive potential was applied (30 seconds, +0.7V vs. carbon quasi-reference electrode). At this point the silver was oxidized from Ag(0) to Ag(I).

Silver was then deposited onto the electrode, beginning the Anodic Stripping Voltammetry (ASV) portion of the assay. Here, Ag(I) was deposited onto the working electrode with a negative potential (120 seconds, −1.2 V vs. carbon quasireference electrode.)

Silver was then stripped from the electrode, the second step for ASV. The potential of the working electrode was ramped from reducing (−1.0 V) to oxidizing (0 V) at 10 mV/s. When the voltage was at the potential for oxidizing silver, the current peaked. The area under the peak is directly related to the number of silver atoms oxidized. This number is then also directly related to the number of silver particles the analyte was able to successfully form bound complexes with.

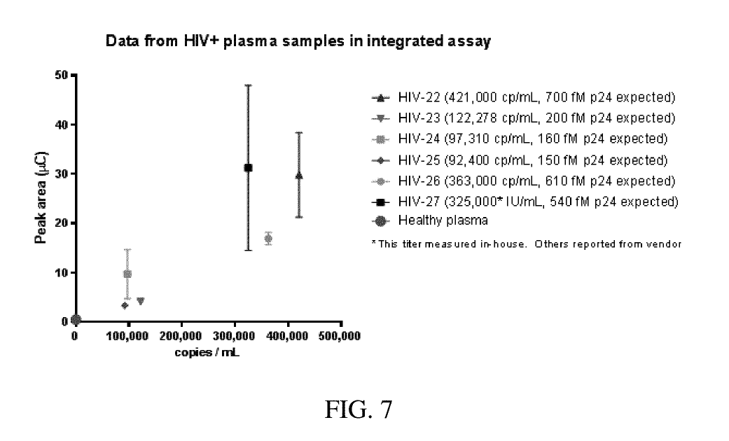

100% of the virions from HIV-23, 24, 25, 27 were captured in the virion capture module, as measured by RT-PCR. Only 50% of the virions from HIV-22 (blue) and HIV-26 (orange) were captured. Results are shown in FIG. 7.

### Example 5

The following example demonstrates that the methods and electrolytes described herein do not release the silver particles from the antigen according to certain embodiments described herein.

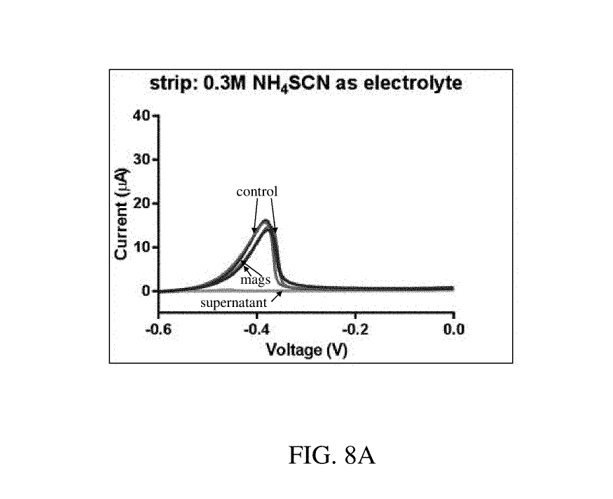

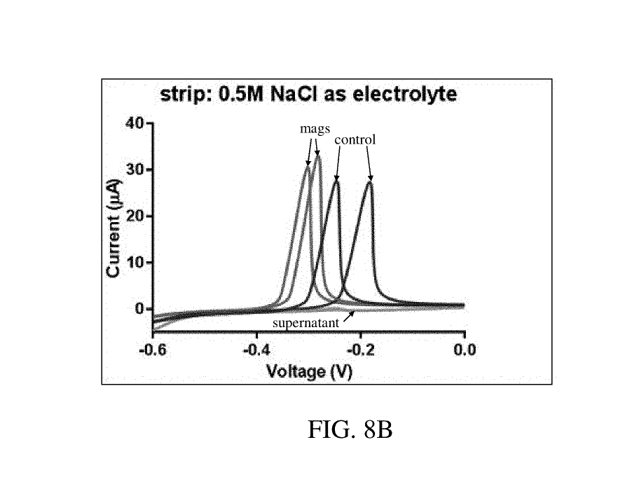

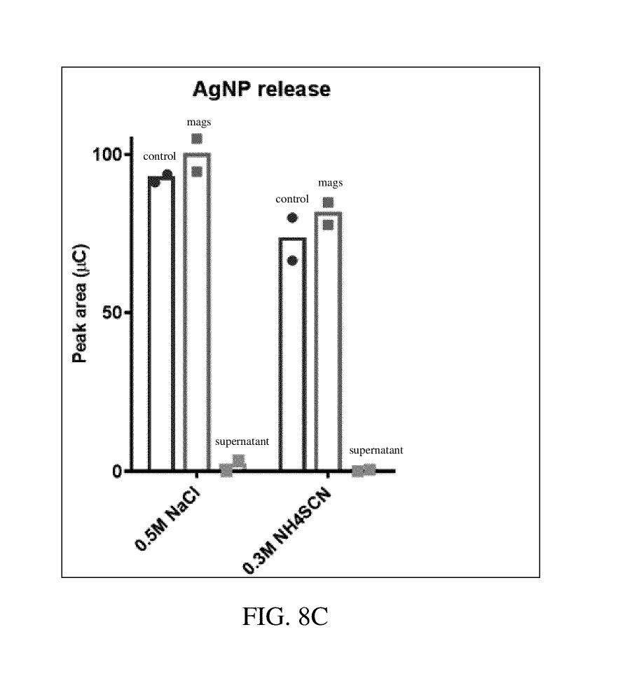

As described in Example 4, and schematized in FIG. 2A, silver particles were added to p24 HIV antigen and the supernatant was collected. As shown in FIGS. 8A-8C, substantially no silver particles were present in the supernatant, indicating that the electrolyte did not release the silver particles from the antigen when the bound complex was exposed to the electrolyte.

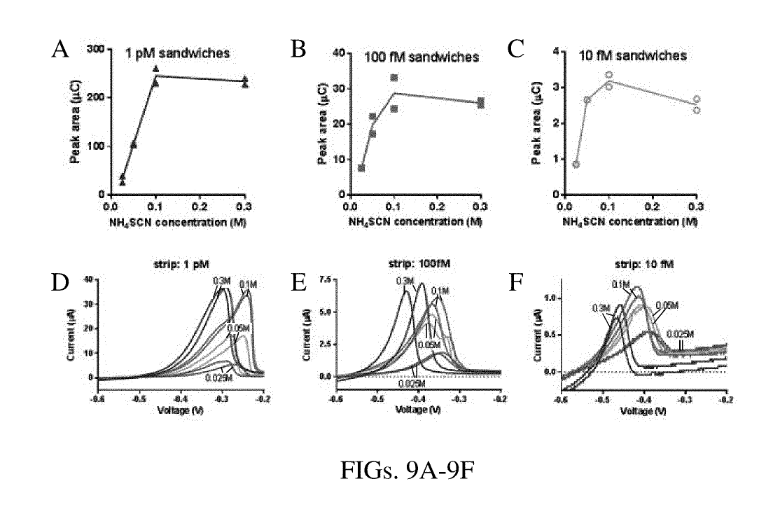

FIGS. 9A-9F show the effect of increasing the concentration of the electrolyte (NH₄SCN), which resulted in changes in the peak area and shape. 0.1M NH4SCN provided the largest peak area but distorted the shape of the peaks at high silver concentrations. 0.5M NH4SCN, 1M NH4SCN, and 5 M NH4SCN were also tried and all of these decreased signal even farther.

Example 5 was performed with “defined bound complexes” where a known concentration of silver particles were introduced to the immunoassay with a high concentration of p24 on the capture structures. The theoretical peak area for 1 pM of silver particles is approximately 1100 μC.

### Example 6

The following example demonstrates a prophetic example and a general method for determining and/or quantifying an analyte from a blood sample, according to the methods described herein. Plasma is first separated from blood components using a membrane based separator.

Analytes can include soluble protein markers found in plasma, such as Troponin I, or protein markers associated with or contained within pathogens such as bacteria or viruses, for example, core antigen of HCV.

For soluble protein markers, such as Troponin I, simple plasma dilution with a buffer containing, for example PBS, 0.1% casein, 0.05% Tween-20 and 0.5 mg/ml mouse IgG can be required. Dilution can be performed, for example, by combining 25 μl of plasma sample with 25 μl buffer solution.

For analytes contained within virion structures, such as HCV, virions present in plasma sample may be lysed first in a lysis solution containing detergents, and/or acid, and/or denaturants and/or reducing agents to release the core antigen, which can be subsequently detected (for example, as described in Example 1). The lysis step opens HCV particles to release the core antigen, monomerizes the core antigen, inactivates the host-derived antibodies against the core antigen, dissociates the core antigen from the interactions with blood components, endogenous antibodies against the core antigen, and dissociates the core antigen from the interactions with blood components other than the antibody against core antigen.

Lysing can be performed, for example, by combining 25 μl of plasma sample with 25 μl treatment solution, of the following composition:

10% sodium dodecyl sulfate (SDS)

4% n-Dodecyl-beta-D-maltoside (DDM)

Incubated at 56° C. for 15-30 minutes. 50 μl treated sample can be mixed, for example, with 50 μl of reaction buffer, of the following composition:

5 mM Ethylenediaminetetraacetic acid (EDTA)

0.1 M NaCl

3% mouse serum

0.3% Triton X-100

0.1M phosphate buffer pH 7.2.

In another example, lysing can be performed, for example, by combining 25 μl of plasma sample with 25 μl of treatment solution, of the following composition:

0.5M HCl,

4% NP-40 lysis buffer.

Incubated at 37° C. for 5 min. Treated sample can then be neutralized with 50 ul of buffer of the following composition:

0.4M NaOH

0.45M NaH₂PO₄ (pH 7.3)

4% sarcosinate.

The lysed components (“lysate”) in the lysis may contain detergents at a concentration in which detection may not be accurately performed. Therefore, the first step of the detection module may include dilution of the lysate such that the matrix is compatible with the detection assay. The dilution factor is generally a function of the volume of the lysate, the concentration of the detergents, and/or the robustness of downstream components to the chosen detergents.

50 μg of 200 nm analyte specific magnetic beads may be added to the diluted lysate or diluted plasma and sample may be incubated at room temperature for 5-15 minutes. Prior to running the assay, the capture structures can be, in some cases, coated with antibodies able to capture the analyte. For example, protocols for coating the particles with antibodies included EDC coupling to carboxylic acids present on the surface of the particles. The size of the capture structure may be chosen as a balance between steric hindrance (e.g., smaller particles are generally more likely to successfully bind to an analyte on a large silver particle) and magnetic moment (e.g., larger particles generally have a higher magnetic moment and are more easily removed from solution with a magnet). An exemplary schematic of the above procedure is shown in FIG. 2A.

The solution of analyte and capture structures may be placed on a magnetic stage. All capture structures, including those with analyte are generally gathered near the magnet. The supernatant, including all unbound sample, may then be removed. Wash buffer may then be added and the capture structures, including all bound analyte, may be resuspended by vortexing and pipetting up and down. The resuspended captured structures may then be put back on the stage and the wash buffer was removed. The wash buffer may be composed of, for example, 0.1% Casein and 0.05% tween-20 in PBS.

3 μg of 200 nm analyte specific silver particles may be added to the diluted lysate. Particles may be incubated with the lysate at room temperature for 15-60 minutes. Prior to running the assay, the silver particles may be coated with antibodies able to capture the analyte. For example, protocols for conjugating antibodies included EDC coupling of antibodies to carboxylic acids on lipoic acid molecules that have already been attached to the silver particles.

The size of the silver particle may be chosen as a balance between amplification (e.g., larger silver particles generally lead to larger amplification during electrochemical quantification) and labeling efficiency (e.g., smaller silver particles generally lead to improved ability to label every antigen with a silver particle and a capture structure.) The supernatant, including all unbound silver particles, may be removed. Wash buffer may be then added and the capture structures, including all bound complexes, may be resuspended by vortexing and pipetting up and down. The resuspended bound complexes may be then put back on the stage and the wash buffer may be removed. A schematic of the bound complexes is shown in FIG. 2B.

The wash buffer may be composed of, for example, 0.1% Casein and 0.05% tween-20 in PBS.

The capture structures and bound complexes may be then resuspended in the electrolyte for the final electrochemical quantification of silver content. The electrolyte may be, for example, 0.1 M NH₄SCN. Other electrolytes such as NaCl, KCl, NaBr, and/or KI may also be used.

In an exemplary embodiment, the remaining steps involve anodic stripping voltammetry (ASV) detection strategy and are schematized in FIG. 2C. The solution containing electrolyte, capture structures, and bound complexes may be then transferred to a screen-printed electrode where the working, counter, and reference electrodes may all include, for example, carbon ink. A magnet may be placed under the working electrode. After all capture structures migrated to the surface of the electrode, a positive potential can be applied (30 seconds, +0.7V vs. carbon quasi-reference electrode). At this point the silver oxidizes from Ag(0) to Ag(I).

Silver can then be deposited onto the electrode, beginning the ASV portion of the assay. Here, Ag(I) can be deposited onto the working electrode with a negative potential (120 seconds, −1.2 V vs. carbon quasi-reference electrode.)

Silver can then be stripped from the electrode, the second step for ASV. The potential of the working electrode can be ramped from reducing (−1.0 V) to oxidizing (0 V) at 10 mV/s. When the voltage is at the potential for oxidizing silver, the current peaks. The area under the peak is generally directly related to the number of silver atoms oxidized. This number is then also generally proportional to the number of silver particles the analyte was able to successfully form bound complexes with.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, and/or geometric relationship include, but are not limited to terms descriptive of: shape—such as, round, square, circular/circle, rectangular/rectangle, triangular/triangle, cylindrical/cylinder, elliptical/ellipse, (n)polygonal/(n)polygon, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; direction—such as, north, south, east, west, etc.; surface and/or bulk material properties and/or spatial/temporal resolution and/or distribution—such as, smooth, reflective, transparent, clear, opaque, rigid, impermeable, uniform(ly), inert, non-wettable, insoluble, steady, invariant, constant, homogeneous, etc.; as well as many others that would be apparent to those skilled in the relevant arts. As one example, a fabricated article that would described herein as being “square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described. As another example, two or more fabricated articles that would described herein as being “aligned” would not require such articles to have faces or sides that are perfectly aligned (indeed, such an article can only exist as a mathematical abstraction), but rather, the arrangement of such articles should be interpreted as approximating “aligned,” as defined mathematically, to an extent typically achievable and achieved for the recited fabrication technique as would be understood by those skilled in the art or as specifically described.

What is claimed:

1. A method for quantifying an analyte in a fluid, comprising:
introducing or exposing a plurality of capture structures and a plurality of metal-containing particles to a fluid comprising the analyte such that the analyte binds with both a capture structure and a metal-containing particle to form a bound complex, wherein the plurality of metal-containing particles comprise a metal, and wherein prior to forming the bound complex, the plurality of metal-containing particles have an average particle size of at least 100 nm;
separating any unbound metal-containing particles from the bound complex;
exposing the bound complex to an electrolyte;
applying an electric potential to oxidize at least a portion of the metal from the metal-containing particles;
applying an electric potential to deposit at least a portion of the metal onto a working electrode; and
measuring current by changing a voltage on the working electrode to determine the amount of analyte present in the fluid.

2. A method for quantifying an analyte in a fluid, comprising:
introducing or exposing a plurality of capture structures and a plurality of metal-containing particles to a fluid comprising the analyte such that the analyte binds with both a capture structure and a metal-containing particle to form a bound complex, wherein the plurality of metal-containing particles comprise a metal;
separating any unbound metal-containing particles from the bound complex;
exposing the bound complex to an electrolyte, wherein the exposing step does not release the silver particle from the bound complex;
applying an electric potential to oxidize at least a portion of the metal from the metal-containing particles;
applying an electric potential to deposit at least a portion of the metal onto a working electrode; and
measuring current by changing a voltage on the working electrode to determine the amount of analyte present in the fluid.

3-4. (canceled)

5. A method for quantifying an analyte in a sample, comprising:
adding, to a sample comprising a plurality of analyte-containing biological particles, a buffer solution and a capture substrate such that at least a portion of the analyte-containing biological particles attach to the capture substrate;
removing any components not attached to the capture substrate;
exposing an analyte from the analyte-containing biological particles such that the analyte is available to form a bound complex;
introducing, to the analyte, a plurality of capture structures and a plurality of metal-containing particles such that the analyte binds with both a capture structure and a metal-containing particle to form the bound complex;
separating any unbound metal-containing particles from the bound complex;
exposing the bound complex to an electrolyte;
applying an electric potential to oxidize at least a portion of the metal from the metal-containing particles;
applying an electric potential to deposit at least a portion of the metal onto a working electrode; and
measuring current by changing a voltage on the working electrode to determine the amount of analyte present.

6-7. (canceled)

8. A method as in claim 5, wherein the buffer solution comprises a chlorine-containing salt, metal acetate, and/or a salt selected from the group consisting of sodium acetate, zinc acetate, cooper acetate, NaCl, LiCl, CsCl, and combinations thereof.

9. A method as in claim 5, wherein the buffer solution comprises a salt having a concentration of 1 mM to 5 M.

10-13. (canceled)

14. A method as in claim 5, wherein the plurality of metal-containing particles have an average particle size of at least 100 nm and less than or equal to 2 microns.

15. (canceled)

16. A method as in claim 5, wherein the plurality of metal-containing particles are conjugated with a first antibody that can bind to the analyte.

17. A method as in claim 5, wherein the metal-containing particles comprise silver, cobalt, bismuth, cadmium, lead, zinc, tin, nickel, chromium, copper, or gold.

18. (canceled)

19. A method as in claim 5, wherein the plurality of capture structures have a mean cross-sectional dimension of at least 40 nm and less than or equal to 5 microns.

20. A method as in claim 5, wherein the plurality of capture structures comprise a magnetic material.

21. A method as in claim 5, wherein the plurality of capture structures are conjugated with a second antibody that can bind to the analyte.

22-24. (canceled)

25. A method as in claim 5, wherein the electrolyte does not remove the silver particle from the bound complex upon introduction of the electrolyte.

26. (canceled)

27. A method as in claim 5, wherein applying the electric potential to oxidize at least a portion of the metal from the metal-containing particles directly oxidizes the plurality of silver particles from Ag⁰ to Ag⁺.

28. A method as in claim 5, wherein changing a voltage on the working electrode comprises increasing the electric potential to a voltage sufficient to oxidize the metal species present.

29. (canceled)

30. A method as in claim 5, wherein the plurality of metal-containing particles are directly oxidized with the applied potential without the use of an oxidizing agent.

31. (canceled)

32. A method as in claim 5, wherein the capture substrate non-specifically captures the virion.

33. A method as in claim 5, wherein the analyte-containing biological particle is a blood cell.

34-38. (canceled)

39. A method as in claim 5, wherein prior to removing any components not bound to the capture substrate, the sample is mixed with the buffer solution for between 1-5 minutes.

40. (canceled)

41. A method as in claim 5, wherein the sample is a whole blood sample or plasma sample.

42. A method as in claim 5, wherein the exposing step occurs prior to the step of introducing the plurality of capture structures and the plurality of metal-containing particles.

43. A method as in claim 5, wherein the exposing step occurs after the step of introducing the plurality of capture structures and the plurality of metal-containing particles.

44. A method as in claim 5, wherein exposing the analyte from the analyte-containing biological particles comprises adding a lysing solution to release the analyte from the analyte-containing biological particles.

45. A method as in claim 5, wherein exposing the analyte from the analyte-containing biological particles comprises mechanical agitation or shearing.

46. A method as in claim 5, wherein removing any components not attached to the capture substrate comprises magnetic separation and/or washing.

47-48. (canceled)

49. A method as in claim 5, wherein the analyte-containing biological particle is a virion, a bacterium, a protein complex, an exosome, a cell, or fungi.

50. A method as in claim 5, wherein the analyte is an antigen, a protein, a lipid, a glycolipid, nucleic acid, an amino acid, membrane protein (e.g., from a bacterium), a hormone, a small molecule, a metabolite, or a drug.
